(19) United States
(12) Patent Application Publication
(10) Pub. No.: US 2018/0278421 A1
(43) Pub. Date: Sep. 27, 2018

(54) SECURE AND NOISE-TOLERANT DIGITAL AUTHENTICATION OR IDENTIFICATION

(71) Applicants: Florida Atlantic University, Boca Raton, FL (US); Zebrapet LLC, Boca Raton, FL (US)

(72) Inventors: Koray Karabina, Boca Raton, FL (US); Onur Canpolat, San Diego, CA (US)

(21) Appl. No.: 15/522,874

(22) PCT Filed: Oct. 30, 2015
(86) PCT No.: PCT/US15/58290

§ 371 Date: Apr. 28, 2017

Related U.S. Application Data
(60) Provisional application No. 62/073,395, filed on Oct. 31, 2014.
(60) Provisional application No. 62/138,625, filed on Mar. 26, 2015.

(51) Int. Cl. H04L 9/32; G06K 9/00; G06K 9/62

(52) U.S. Cl. CPC H04L 9/3231; G06K 9/00926; G06F 21/32; G06K 9/6215; G06K 9/624; G06K 9/00087

(57) ABSTRACT

Secure data processing is described. Particular systems and methods involve enrollment units and methods, where the method includes obtaining an input data representing a raw data associated with a user, generating a template for the input data, and storing the template in an enrollment database, optionally with an identifier for the user. Other systems and method involve comparison or authentication units or methods, where the method involves obtaining templates corresponding to data sets to be compared, comparing the templates using a pre-defined comparison function to yield a similarity measure, and if the similarity measure meets a similarity criterion, determining that the data sets are from the same source. In the systems and methods, the templates are secure and noise tolerant templates configured to reveal limited features of the data set and to prevent reconstruction of the data set from the template.

### CROSS-REFERENCE TO RELATED APPLICATIONS

This application claims the benefit of and priority to U.S. Provisional Patent Application No. 62/073,395, filed Oct. 31, 2014, and U.S. Provisional Patent Application No. 62/138,625, filed Mar. 26, 2015, the contents of both of which are herein incorporated by reference in their entireties as if fully set forth herein.

### FIELD OF THE INVENTION

The various aspects of the present disclosure relates to digital authentication and identification and applications, and more specifically to apparatus and methods for secure and noise-tolerant authentication and identification schemes.

### BACKGROUND

Biometrics has proved itself as a very powerful technology in designing digital authentication and identification schemes. This technology has a great potential of creating secure and efficient applications such as secure login, border control, and management of healthcare records. Research and development efforts for creating secure biometric schemes date back to 1994. Despite two decades of efforts, studies in the last five years indicate that challenging security and privacy problems still remain to be addressed. In the absence of addressing effectively the confidentiality and privacy problems both in theory and practice, society will not fully benefit from using biometrics in real-life applications.

Conventional cryptosystems are of very limited use in securing biometric systems because a user's biometric samples are not likely to be identical during enrollment and authentication, unlike noise-free and repeatable measurements in password-based and token-based authentication schemes. Moreover, users remain concerned about maintaining biometric samples secure and private. However, biometric based authentication and identification schemes are still preferred because of the difficulty in reproducing the biometric samples. Therefore, there is a need for new authentication and identification schemes which are noise-tolerant, secure, and privacy-preserving.

### SUMMARY

The various aspects of the present disclosure concern secure and noise-tolerant authentication and identification schemes. Particular systems and methods involve enrollment methods, where the methods include obtaining an input data representing a raw data associated with a user, generating a template for the input data, and storing the template in an enrollment database, optionally with an identifier for the user. Other systems and methods involve comparison or authentication methods, where the methods involve obtaining templates corresponding to data sets to be compared, comparing the templates using a pre-defined comparison function to yield a similarity measure, and if the similarity measure meets a similarity criterion, determining that the data sets match.

In the systems and methods, the templates are secure and noise tolerant templates configured to reveal limited features of a data set and to prevent reconstruction of the data set from the template.

In a first embodiment, a method is provided. The method includes obtaining an input data set representing a raw data set associated with a user and generating a secure and noise tolerant template for the input data set, where the template is configured to reveal limited features of the input data set and to prevent reconstruction of the input data set from the template. The method also includes storing the template in an enrollment database, optionally with an identifier for the user.

In some configurations of the first embodiment, the obtaining of the input data set includes receiving the raw data associated with the user via a biometric scanning device and converting the raw data into the input data set.

In some configurations of the first embodiment, the obtaining of the input data set includes receiving the raw data associated with the user via at least one of an audio input device, an image input device, a video input device, or a computer interface input device.

In some configurations of the first embodiment, the obtaining further includes representing the raw data set using one or more vectors to yield the input data set. In such configurations, the generating includes mapping the one or more vectors in the input data set to one or more new vectors with elements in a pre-defined algebraic set, applying a pre-defined algebraic operator to the one or more new vectors to yield a projection of the input data set, and deriving the template from the projection based on a noise tolerance bound. In some cases, the mapping further includes applying a randomization procedure to randomize at least a portion of one or more new vectors.

In a second embodiment, a method is provided. The method includes obtaining a pair of templates corresponding to first and second input data sets to be compared, each of the pair of templates being a secure and noise tolerant template configured to reveal limited features of the corresponding input data set and to prevent reconstruction of the corresponding input data set from the secure and noise tolerant template. The method also includes comparing the pair of templates using a pre-defined comparison function to yield a similarity measure and, if the similarity measure meets a similarity criteria, determining that the first and the second input data are the same.

In some configurations of the second embodiment, the obtaining includes receiving the first raw data, converting the raw data into the first input data set, generating a first one of the pair of templates corresponding to the first input data, and retrieving a second one of the pair of templates from a database.

In some configurations of the second embodiment, the method can further include receiving a user identifier associated with the first input data set and the retrieving can include identifying the second one of the pair of templates in the database based on the user identifier.

In some configurations of the second embodiment, the comparing can include evaluating the pair of templates using the pre-defined comparison function to yield a comparison result, configuring the similarity measure to indicate the first and the second input data are from a same source if the comparison result is that the pair of templates are identical, and performing a decomposition procedure using the pair of templates and configuring the similarity measure according to the result of the decomposition procedure if the comparison result is that the pair of templates are different.

The performing of the decomposition procedure can include deriving, using a mathematical function of the pair of templates, an element from the algebraic, decomposing the element as a product of elements of the algebraic set with a set of corresponding factors, configuring the similarity measure to indicate the first and the second input data lie within the noise tolerance bound if the set of corresponding factors belongs to a pre-defined subset of the algebraic set, and configuring the similarity measure to indicate the first and the second input data lie outside the noise tolerance bound if the set of corresponding factors are outside the pre-defined subset of the algebraic set.

In some configurations of the second embodiment, the comparing includes evaluating the pair of templates using the pre-defined comparison function to yield a comparison result, configuring the similarity measure to indicate the first and the second input data from the same source if the comparison result is that at least a portion of the pair of templates are identical, and performing a decomposition procedure using the pair of templates and configuring the similarity measure according to the result of the decomposition procedure if the comparison result is that the pair of templates are different.

In a third embodiment, a computer-readable medium is provided, having stored thereon a plurality for instructions for causing a computing device to perform any of methods of the first and second embodiments.

In a fourth embodiment, an apparatus is provided. The apparatus includes at least one processing element and a computer-readable medium having stored thereon a plurality for instructions for causing the processing element to perform any of the methods of the first and second embodiments.

In a fifth embodiment, there is provided an apparatus. The apparatus includes a set of data processing components and at least one database unit configured for storing data. In the apparatus, the set of data processing components defines one or more enrollment units, each of the enrollment units configured to obtain an input data set representing a raw data set associated with a user, generate a secure and noise tolerant template for the input data set, and store the template in an enrollment database, optionally with an identifier for the user, where the template is configured to reveal limited features of the input data set and to prevent reconstruction of the input data set from the template.

In some configurations of the fifth embodiment, each of the enrollment units includes a first component for obtaining the raw data set associated with the user, and a second component for converting the raw data into the input data set.

The first component can be at least one of a biometric scanner device, an audio input device, an image input device, a video input device, or a computer interface input device. The second component can be configured to convert the raw data set into one or more vectors to yield the input data set and each of the enrollment units can include a third component. The third component can be configured for generating the template by mapping the one or more vectors in the input data set to one or more new vectors with elements in a pre-defined algebraic set, applying a pre-defined algebraic operator to the one or more new vectors to yield a projection of the input data set, and deriving the template from the projection based on a noise tolerance bound. The third component can also be configured for performing the mapping by applying a randomization procedure to randomize at least a portion of the one or more new vectors.

In a sixth embodiment, there is provided an apparatus. The apparatus includes a set of data processing components. The set of data processing components defines one or more comparison units, each of the comparison units configured to obtain a pair of templates corresponding to first and second input data sets to be compared, comparing the pair of templates using a pre-defined comparison function to yield a similarity measure, and determining that the first and the second input data are the same if the similarity measure meets a similarity criteria. In the apparatus, each of the pair of templates is a secure and noise tolerant template configured to reveal limited features of the corresponding input data set and to prevent reconstruction of the corresponding input data set from the secure and noise tolerant template.

In some configurations of the sixth embodiment, the apparatus can further include a database and each of the comparison units can include a first component for receiving the first input data set, a second component for generating a first one of the pair of templates corresponding to the first input data, and a third component for receiving the first one of the pair of templates, retrieving a second one of the pair of templates from a database, and performing the determining.

In some configurations of the sixth embodiment, the third component is further configured for receiving a user identifier associated with the first input data set and for identifying the second one of the pair of templates in the database based on the user identifier.

In some configurations of the sixth embodiment, the apparatus can further include a fourth component configured for performing the comparing by evaluating the pair of templates using the pre-defined comparison function to yield a comparison result, configuring the similarity measure to indicate the first and the second input data are from a same source if the comparison result is that the pair of templates are identical, performing a decomposition procedure using the pair of templates, and configuring the similarity measure according to the result of the decomposition procedure if the comparison result is that the pair of templates are different.

In some configurations of the sixth embodiment, the decomposition procedure can include deriving, using a mathematical function of the pair of templates, an element from the algebraic set, decomposing the element as a product of elements of the algebraic set with a set of corresponding factors, configuring the similarity measure to indicate the first and the second input data lie within the noise tolerance bound if the set of corresponding factors belongs to a pre-defined subset of the algebraic set, and configuring the similarity measure to indicate the first and the second input data lie outside the noise tolerance bound if the set of corresponding factors are outside the pre-defined subset of the algebraic set.

In some configurations of the sixth embodiment, the apparatus can further include a fourth component configured for performing the comparing by evaluating the pair of templates using the pre-defined comparison function to yield a comparison result, configuring the similarity measure to indicate the first and the second input data are from a same source if the comparison result is that the pair of templates are identical, and performing a decomposition procedure using the pair of templates and configuring the similarity measure according to the result of the decomposition procedure if the comparison result is that the pair of templates are different.

In the fifth and sixth embodiments, the components therein can communicate with each other using secure and authentic communications and components can take action (such as halt or give error message) if the communication is not secure or authentic.

In a seventh embodiment, there is provided a method. The method includes obtaining location and orientation information for each a plurality of minutiae associated with a fingerprint, identifying an n-element set corresponding to each one of the plurality of minutiae, each n-element set comprising n others of the plurality of minutiae neighboring the corresponding one of the plurality of minutiae, determining a first set of vectors for each n-element neighboring set comprising distance and orientation information for each one of the n others of the plurality of minutiae with respect to the corresponding one of the plurality of minutiae, transforming the first set of vectors into a second set of vectors, each vector of the second set of vectors having a fixed length, and storing the second set of vectors as the vector representation of the fingerprint.

In the seventh embodiment, the identifying can further include selecting the n others of the plurality of minutiae to be pairwise distinct and to be the n closest to the corresponding one of the plurality of minutiae.

In the seventh embodiment, each vector from the first set of vectors can be associated with a one of the n others of the plurality of minutiae, and each vector can include a distance between the one of the n others of the plurality of minutiae and the corresponding one of the plurality of minutiae, a first relative angle between a slope from the one of the n others of the plurality of minutiae and the corresponding one of the plurality of minutiae and an orientation of the corresponding one of the plurality of minutiae, and a second relative angle between an orientation of the one of the n others of the plurality of minutiae and the orientation of the corresponding one of the plurality of minutiae.

In the seventh embodiment, the transforming can include applying a set of scaling vector to the first set of vectors to yield the second set of vectors.

In an eighth embodiment, a computer-readable medium is provided, having stored thereon a plurality for instructions for causing a computing device to perform any of methods of the seventh embodiment.

In a ninth embodiment, an apparatus is provided. The apparatus includes at least one processing element and a computer-readable medium having stored thereon a plurality for instructions for causing the processing element to perform any of the methods seventh embodiment.

### BRIEF DESCRIPTION OF THE DRAWINGS

FIG. 1 shows a schematic view of a system in accordance with the various embodiments;

FIG. 2 shows a schematic view of an enrollment unit in accordance with the various embodiments;

FIG. 3 shows a schematic view of a verification unit in accordance with the various embodiments;

FIGS. 4A, 4B, 4C, and 4D show various arrangements of enrollment units with respect to verification units in accordance with the various embodiments;

FIG. 5 shows an enrollment method according to a particular embodiment;

FIG. 6 shows a verification method according to a particular embodiment; and

FIG. 7A and FIG. 7B illustrate exemplary possible system embodiments.

### DETAILED DESCRIPTION

The various aspects of the present disclosure are described with reference to the attached figures, wherein like reference numerals are used throughout the figures to designate similar or equivalent elements. The figures are not drawn to scale and they are provided merely to illustrate the instant invention. Several aspects of the present disclosure are described below with reference to example applications for illustration. It should be understood that numerous specific details, relationships, and methods are set forth to provide a full understanding of the various aspects of the present disclosure. One having ordinary skill in the relevant art, however, will readily recognize that the various aspects of the present disclosure can be practiced without one or more of the specific details or with other methods. In other instances, well-known structures or operations are not shown in detail to avoid obscuring the invention. The various aspects of the present disclosure are not limited by the illustrated ordering of acts or events, as some acts may occur in different orders and/or concurrently with other acts or events. Furthermore, not all illustrated acts or events are required to implement a methodology in accordance with the various aspects of the present disclosure.

The various aspects of the present disclosure are directed to a framework and a protocol for performing a cryptographically secure and privacy-preserving comparison of data items. The comparison may be performed in different forms and settings:
(1) A single data item against another data item. (e.g., Comparison of two biometric data, two passwords, two signatures, two test/survey results.)
(2) A single data item against several data items. (e.g., Comparison of a biometric data against a set of biometric data, a password against a set of a passwords, a signature against a set of signatures, a test/survey result against set of test/survey results.)
(3) A set of data items against another set of data items. (e.g., Comparison of a set of biometric data against another set of biometric data, a set of passwords against another set of a passwords, a set of signatures against another set of signatures, a set of test/survey results against another set of test/survey results.

In the various aspects of the present disclosure, such a data comparison can be used for purposes of authentication, identification, similarity-finding protocols based on biometric data, passwords, analysis of hand-writing characteristics, and obtaining answers to tests/surveys, to name a few. These can be then applied to a wide range of applications, such as providing cryptographically secure and privacy-preserving biometric based access systems and data analysis from smart-meters.

Some aspects of the present disclosure propose a new scheme NTT-Sec for extracting secure template of noisy data and its comparison. The security analysis and implementation results show that NTT-Sec is practical and compares favorably to previously known schemes. NTT-Sec has strong security features with respect to irreversibility and indistinguishability notions.

Component Framework

The protocols described herein can be implemented using wide range of components. In particular embodiments, the various operations for implementing the framework and protocols described herein can be performed by dividing tasks among different classes of components that can be configured to interact with one another in a variety of ways. A description of each of these classes of components, including input, output, and other capabilities, is provided below.

Class 1 Components (C₁ᵢ). A component in this class can be any device for acquiring the biometric or any other type of data to be secured or compared. Examples of class 1 components can include a biometric scanner, a non-biometric scanner, a recorder, a computer, a bearable or wearable device, a cloud computing device, or any other type of device for obtaining an input of interest. Thus, the input to a class 1 component is some raw form of data to be secured or compared. For example, raw biometric data, a password, text data, test data, or survey data, to name a few. Given a specific input, the output or action of a class 1 component is the generation of a digital or a hard-copy representation of the input. For example, a digital or hard-copy representation of biometric data, password, text, answers to a test or a survey, etc. The digital or hard-copy representation may be, some embodiments, as image. However, in other embodiments, the representation may be alphanumeric information representing the input. In still other embodiments, The digital or hard-copy representation may be a representation of audio or video data.

It should be noted that class 1 components, and all other components discussed herein, can be capable of performing cryptographic functions. For example, a component may be capable of performing public and private key encryption, signing messages, verifying signatures, etc. Thus, if some input to the component is encrypted and signed, the component can be configured to decrypt the input, and verify the signature on it. Further, the component can also be configured to encrypt and sign its output. In this manner communications between different components can be secure (i.e., maintain the data private or hidden) and authentic (i.e., prevent tampering with the data and/or ascertain such tampering has not occurred). Further, the components can also be configured to halt any processes or signal an error message upon detecting that a communications is not secure or not authentic.

Class 2 Components (C₂ᵢ). A component in this class can any type of computing device or system for processing input data of interest and generating output data representing a characterization of the input data. For example, a class 2 component can include a biometric data processing system, a test or a survey result scanner, a password scanner, or any other types of device components configured for receiving input data and processing the input data to output some characterization the input data. The input to a class 2 component can be any digital or a hard-copy representation of data if interest, such as the output of a class 1 component. As to the output, a class 2 component is configured to output the distinctive characteristics of the input. For example, the output of a class 2 component may be the distinctive characteristics of a fingerprint or other biometric data, an ordered sequence of answers to a test or survey, distinctive characteristics in handwriting data, text data, image data, audio data, or video data. or even ordered sequence of characters in the password. However, the present disclosure contemplates that any type of input data can be analyzed by a class 2 component to generate output data representing the characteristics features of such input data.

Class 3 Components (C₃ᵢ). A component in this class can be any type of computing device or system for performing mathematical, physical, or cryptographic operations for generating secure and privacy preserving data based on input data. In various embodiments, the input to a class 3 component is generally a set of input data concerning the distinctive characteristics of the data of interest. For example, the input to a class 3 component can be an output of a class 2 component. Given such an input, the class 3 component is configured to generate an output consisting of a cryptographically secure and privacy-preserving transformation of the input. This can be performed using mathematical, physical, or cryptographic operations. For example, using the NTT-Sec scheme described below. Thus, the result is a template representing a transformed version of the distinctive features of the data of interest, a cryptographic hashing of such features, a permutation of such features, or any combinations thereof. That is, a template revealing limited information to enable the user to be identified from the template alone or to reconstruct the user's input from the template alone.

Class 4 Components (C4ᵢ). A component in this class can be any type of computing device or system for storing and managing data. In various embodiments, a class 4 component will generally be configured to receive two types of input: Type-I and Type-II. A type-I input can be data that has been transformed in a cryptographically secure and privacy-preserving manner (e.g., the templates generated by class 3 components) and that may be compared to some other data, as described below in further detail. The type-I input can also contain a corresponding identifier (e.g. a user name or similar designating information) associated with the data. The identifier may also identify a type of data associates with the template (e.g., thumbprint, retina scan, or other biometric data type). However, in some embodiments, the identifier part of the input may be blank (i.e., have no identifier). Thus, a type-I input to a class 4 component can be, for example, the output of a class 3 component, with or without identifier data. In response to the type-I input, the class 4 component is configured to store the input for later access. A type-II input can be a query-based input for retrieving data stored in the class 4 component. For example, a type-II input can be a query for data associated with a specific identifier or portions thereof. Given a Type-II input, the class 4 component is configured to answer this query based on its stored data. For example, the class 4 input may return all or part of stored data associated with the type-II input.

Class 5 Component (C₅ᵢ). A component in this class can be any type of computing device or system for performing comparison operations. In various embodiments, the input to a class 5 component can be a pair (or a tuple) of templates or secure data sets to be compared, as described in further detail below. In certain embodiments, the input could be two templates from one or more class 4 components, two templates from two class 3 components, or even a template from a class 4 component and a template from a class 3 component. The class 5 component is then configured to output the result of such a comparison. For example, as discussed in greater detail below, the output can be a similarity score or the like indicative of the closeness or similarity of the input data corresponding to the pair of templates.

Class 6 Component (C₆ᵢ). A component in this class can also any type of computing device or component for performing comparison operations. In various embodiments, the input to a class 6 component can be a threshold value or condition and a score or value to be compared thereto, such as the similarity scores output by a class 5 component. The class 6 component is then configured to generate a value indicative of whether or not the threshold value or condition has been met (or not met). For example, the class 6 can simply output “pass” and “fail” values, such as 1 and 0. However, the various aspects of the present disclosure are not limited in this regard and the class 6 component can be configured to supply other types of values to indicate whether or not the threshold value or condition has been met.

Now that exemplary components involved in implementing the methods of the various aspects of the present disclosure have been described, the present disclosure now turns to a discussion of how such components can be combined in particular embodiments.

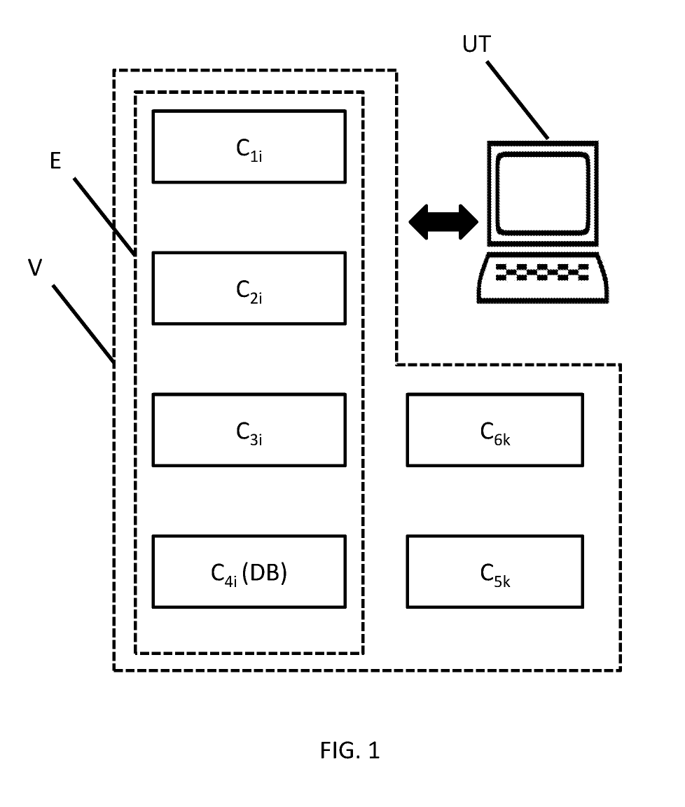

In some embodiments, the components described above can be used to implement a protocol for authentication or comparison. There are two phases in this protocol. In the first phase, an enrollment phase, an enrollment unit is formed using components from class 1, class 2, class 3, and class 4. For example, as shown in FIG. 1, an enrollment unit E can be formed from components C₁ᵢ, C₂ᵢ, C₃ᵢ, and C₄ᵢ. Enrollment unit E can scan biometric data of a user uⱼ using a class 1 component C₁ᵢ, process the biometric data using a class 2 component C₂ᵢ, and produce cryptographically secure and privacy-preserving data dⱼ corresponding to the biometric data (e.g., a template) using a class 3 component C₃ᵢ. In some embodiments, the biometric data can be scanned directly by component C₁ᵢ. In other embodiments, the scan can be performed by component C₁ᵢ in conjunction with other components, such as user terminal UT or other devices. This data (together with an identifier idⱼ) can then be sent to a database DB, consisting of at least class 4 component C₄ᵢ, for storage. In some embodiments, where multiple types of identifying data are being provided (e.g., different types of biometric data), the identifier can also indicate a type for the template being stored.

A user terminal UT may also be associated with the enrollment process. In some configurations, the user terminal UT may be used to facilitate or supplement user input. In other configurations, the user terminal may be used to indicate to the user a success or failure of the enrollment process. Further, in the event the components employ an encryption/decryption/signature/authentication schemes to provide secure and authentic communications amongst themselves, the user terminal UT may also be used to indicate to a user when it is determined that such communications are not secure nor authentic.

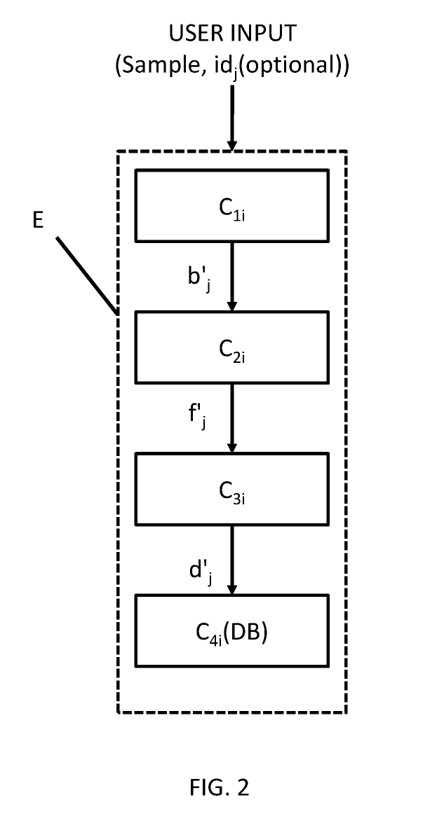

This enrollment process is also illustrated in FIG. 2, showing that (1) class 1 component C₁ᵢ scans a user input (e.g., a thumbprint or the like) and outputs raw biometric data b′ⱼ for user uⱼ to class 2 component C₂ᵢ; (2) class 2 component C₂ᵢ outputs, to class 3 component C₃ᵢ, feature data fⱼ corresponding to raw biometric data b′ⱼ; and (3) class 3 component C₃ᵢ outputs, to class 4 component C₄ᵢ, the cryptographically secure and privacy-preserving data d′ⱼ (e.g., a template) corresponding to the feature data f′ⱼ, and thus the raw biometric data b′ⱼ. This data d′ⱼ can be provided to a database DB (e.g., class 4 component C₄ᵢ) along with an identifier id′ⱼ.

Thereafter, in a second phase, an authentication phase, when the user uᵢ requests authentication, he accesses a comparison or verification unit consisting of components from class 1, class 2, class 3, class 4, class 5, and class 6. For example, as shown in FIG. 1, a verification unit can be formed from components C₁ᵢ, C₂ᵢ, C₃ᵢ, C₄ᵢ, C₅ᵢ, and C₆ᵢ. First, biometric data of a user uⱼ can be scanned using class component class 1 component C₁ᵢ. Thereafter, the verification unit V can process the biometric data using class 2 component C₂ᵢ, and produce cryptographically secure and privacy-preserving data d′ᵢ correspond to the scanned biometric data using class 3 component C₃ᵢ, and determine whether or not the scanned biometric data d′ⱼ and stored data dⱼ for the user uⱼ match using class 6 component C₆ᵢ. In particular, after the biometric data is scanned and is sent to verification unit V, the verification unit can query the database DB with an identifier idⱼ to obtain corresponding data dⱼ. Next, the verification unit V can forward the data pair (dⱼ,d′ⱼ) to class 5 component C₅ᵢ, which replies back to with some similarity score. Finally, based on the similarity score, the class 6 component C₆ᵢ in verification unit can outputs a signal or value to a user terminal UT (or other device associated with a user) indicating whether or not there is a match.

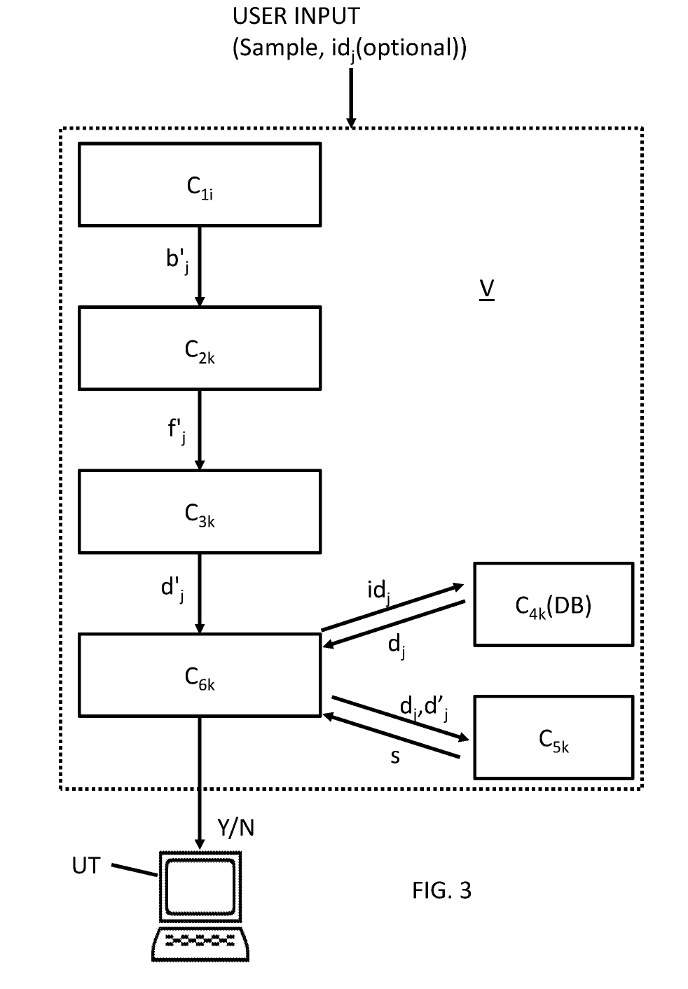

It should be noted that the authentication procedure described above is provided solely as an example, The present disclosure contemplates that in other embodiments, a different interaction of components C₁ᵢ, C₂ᵢ, C₃ᵢ, C₄ᵢ, C₅ᵢ, and C₆ᵢ can be provided. That is, although FIG. 3, component C₆ᵢ as managing the authentication process, the management of the authentication process can be performed by any of the other component in the verification unit or even by user terminal UT.

With regard to user terminal UT, user terminal UT may be used to facilitate or supplement user input. In other configurations, the user terminal may be used to indicate to the user a success or failure of the authentication process. Further, in the event the components employ an encryption/decryption.signature/authentication scheme to provide secure and authentic communications amongst themselves, the user terminal UT may also be used to indicate to a user when it is determined that such communications are not secure nor authentic.

This process is illustrated in FIG. 3, showing that (1) class 1 component C₁ᵢ scans a user input (e.g., a thumbprint or the like) and outputs raw biometric data b′ⱼ for user uⱼ to class 2 component C₂ᵢ of verification unit V; (2) class 2 component C₂ᵢ outputs, to class 3 component C₃ᵢ, feature data f′ⱼ corresponding to this raw biometric data b′ⱼ; (3) class 3 component C₃ᵢ outputs, to class 6 component C₆ᵢ, the cryptographically secure and privacy-preserving data d′ⱼ corresponding to the feature data f′ⱼ, and thus the raw biometric data b′ⱼ; (4) verification unit V queries a database DB (e.g., class 4 component C₄ᵢ) for data dⱼ associated with an identifier idⱼ; (5) verification unit V then provides a data pair (dⱼ,d′ⱼ) to a class 5 component C₅ᵢ to obtain a similarity score s; and (6) the class 6 component C₆ᵢ of verification unit evaluate the similarity score s and outputs whether or not there is a match. This can be outputted, for example to a user terminal UT or other computing device or system, as shown in FIG. 3.

In other embodiments, the components described above can be used to implement a protocol for a friend-matching application or any other type of matching or comparison application. This can involve a similar configuration as that of FIG. 1. During enrollment, users are required to provide some identifiers (pseudoname, e-mail address, etc.) and may be required to answer a multiple choice test that captures their interests (age, gender, location, favorite movies, books, hobbies, etc.). Users' answers can then be provided to an enrollment unit E consisting of components C₁ᵢ, C₂ᵢ, C₃ᵢ, and C₄ᵢ. to produce cryptographically secure and privacy-preserving data for each user uⱼ. This data dⱼ (together with an identifier for a user, idⱼ) can then sent to a database DB (e.g., consisting of a class 4 component C₄ᵢ). Thereafter, another user uₖ can query verification unit V (now operating as a matching or comparison unit) with his data dₖ. The verification unit V can query the database with a blank identifier so as to reveal all of data dⱼ for other users uⱼ to verification unit V. Thereafter using class 5 component C₅ᵢ a similarity score can be generated for each pair (dⱼ,dₖ). Finally, users with high matching scores are communicated to user uₖ via user terminal UT or some other computing device or system.

It should be noted that the present disclosure contemplates that every component in every class can be configured to communicate with each other. Thus, components in any of classes 1-6 can be potentially combined in any number of ways to perform certain tasks or protocols. That is different protocols can be performed using any number and/or permutation of the components in the different classes. Further, the present disclosure contemplates that components forming an enrollment unit or a verification unit need not be co-located. That is, components in an enrollment unit or a verification can be located local or remotely with respect to each other in any combination.

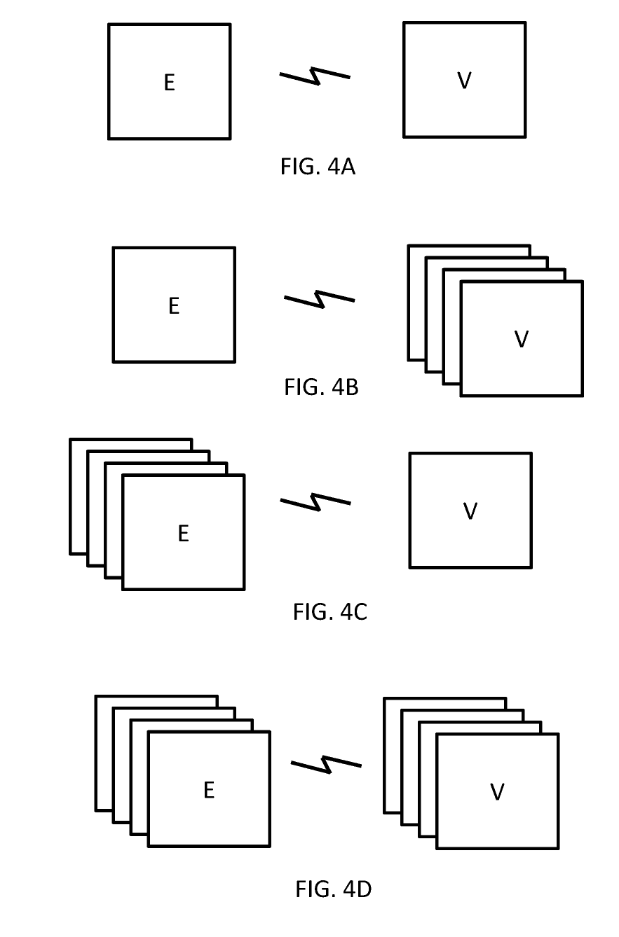

Moreover, any number of enrollment units can be configured to operate with any number of verification units. For example as shown in FIGS. 4A, 4B, 4C, and 4D, enrollment and verification units can operate in a one-to-one relationship (FIG. 4A), a one-to-many relationship (FIG. 4B), a many-to-one relationship (FIG. 4C), or a many-to-many relationship (FIG. 4D). Moreover, a single database or multiple databases can be configured to support any configuration of enrollment and verification units. In some instances, the database(s) may be local to one of the enrollment or verification units or be remote with respect to both.

It should also be noted that while the components in each of classes 1-6 are described as separate components, the present disclosure contemplates that a single device or system can include or embody one or more of the components listed above, include multiple ones of a same component.

As noted above, both the enrollment and verification (or matching/comparison) units rely on components for generating cryptographically secure and privacy-preserving data and for performing a comparison of different sets of said data to obtain a similarity score. One exemplary process is described below.

Noise Tolerant Template Security

The forgoing component framework can be configured to operate with a new method that provides Noise Tolerant Template Security of sensitive data for purposes of generating cryptographically secure and privacy-preserving data and comparisons thereof, henceforward referred to as NTT-Sec.

For ease of illustration of NTT-Sec and its formulation, the present disclosure begins with the assumption that the data x is a binary string of length n, which is some positive integer. Thus, the noise between two data can be measured by the usual Hamming distance function d where d(x,y) counts the total number of indices at which the bits of x and y differ. This setting may be very restrictive for representing and comparing data in some cases. However, it is still a valid setting in practice as justified in several implementations of biometric systems that rely on a fixed length representation of biometric data.

PRELIMINARIES. Let [symbol] _{q} be a finite field with q elements, where q=p^{m} for some prime p and a positive integer m. For simplicity, one c assume that p>3 and m is odd. Denote the order-(q+1) cyclotomic subgroup [symbol] *_{q} by [symbol] . Let [symbol] _{q}²= [symbol] _{q}/[σ]/(f(σ), where f(σ)=σ²−¢ such that c∈ [symbol] _{q} is a quadratic non-residue. It is known that every non-identity element in g=g₀+g₁σ∈ [symbol] can be uniquely represented by an element such that α=(g₀+1)/g₁∈ [symbol] _{q}. such that g=α+σ)(α−σ).

In particular,

$$𝔾 \backslash \{ 1 \} - \{ \frac{α + σ}{α - σ} : α ∈ {𝔽}_{q} \} , \qquad ( 1 )$$

and given any g₀+g₁σ∈ [symbol] \{1} above representation can be obtained by setting α=(g₀+1)/g₁.

Now, let [symbol] ={α_{σ}=(α+σ)/(α−σ): α∈ [symbol] ₚ}, and consider the k-product set

$${S}_{k} = \{ {\sum }_{i = 1}^{k} {v}_{i} : {v}_{i} ∈ ℱ \} ,$$

for some positive integer k. Clearly, Sₖ⊂ [symbol] and so non-identity elements in Sₖ are of the form x_{σ}=(x+σ)/(x−σ) for some x∈ [symbol] _{q}. Furthermore, each such element in Sₖ can symbolically be written as

$$\begin{matrix}{x}_{σ} = \frac{x + σ}{x - σ} \\ = {\prod }_{i = 1}^{k} \frac{{α}_{i} + σ}{{α}_{i} - σ} \\ = \frac{{f}_{0} ( {e}_{1} , … , {e}_{k} ) + {f}_{1} ( {e}_{1} , … , {e}_{k} ) σ}{{f}_{0} ( {e}_{1} , … , {e}_{k} ) - {f}_{1} ( {e}_{1} , … , {e}_{k} ) σ} \\ = \frac{{f}_{0} / {f}_{1} + σ}{{f}_{0} / {f}_{1} - σ} ,\end{matrix} \qquad ( 2 )$$

where f₀=Σᵢ₌₀^{└k/2┘}e_{k-2jc}^{j}, f₁=Σᵢ₌₀^{└(k-1)/2┘}eₖ₋₂ⱼ₋₁c^{j}, e₀=1, and eᵢ=eᵢ(α₁, . . . , αₖ) is the i'th elementary symmetric polynomial in α₁, . . . , αₖ. This identification verifies that given any x_{σ}∈Sₖ, one can efficiently recover υ₁∈ [symbol] with x_{σ}=Πᵢ₌₁^{k}υᵢ when k≤m as follows:
1. Use Weil restriction to the equation f₀−f₁x=0 and obtain m linear equations over [symbol] ₚ with k unknowns e₁, . . . , eₖ.
2. Find a solution (e₁, . . . , eₖ) with eᵢ∈ [symbol] ₚ to this linear system of equations. The existence of a solution is guaranteed by the definition of Sₖ and the fact that x₀∈Sₖ.
3. Construct the polynomial

P(X)=X^{k}−e₁X^{k-1}+e₂X^{k-2}+ . . . (−1)^{k}eₖ. (3)
4. Determine the set of [symbol] ₚ-roots (counted with multiplicities) of the polynomial P, and construct the ordered sequence {α₁, . . . , αₖ: α₁∈ [symbol] ₚ}, which in turn recovers υᵢ=(α₁)_{σ}, as required.
   This procedure is an adaptation of Gaudry's decomposition, which describes an index calculus type algorithm to solve the elliptic curve discrete logarithm problem. This procedure is called a k-decomposition of x_{σ}.

Next, a conjecture is provided about the k-decomposition of elements in [symbol] Conjecture will play a key role when discussing the security and efficiency of the scheme below.

Conjecture 1:

Let q=p^{m}, [symbol] ⊂ [symbol] _{q}, and Sₖ be defined as before. Assume that k and m are fixed and p→∞. Then, O(p^{k}/k!) elements in have a unique k-decomposition for k≤min. Also, O( [symbol] ) elements in [symbol] have O(p^{k-m}/k!) distinct k-decompositions for k>m.

Justification of Conjecture 1.

Let q=p^{m}, [symbol] ⊂ [symbol] , and Sₖ be as specified in the conjecture. Define the set Vₖ of all tuples υ=[υ₁, . . . , υₖ], υᵢ∈ [symbol] , where two tuples υ, w∈Vₖ are assumed to be identical if there exists a permutation π on {1, . . . , k} such that wᵢ=υ_{π(i)} for all i=1, . . . k. Then the size of is

$$\begin{matrix}\vert {V}_{k} \vert = {\sum }_{s = 1}^{k} {\sum }_{{{i}_{1} + … + {i}_{s} = k}_{0 < {i}_{1} \leq … \leq {i}_{s} \leq k}} \frac{p ( p - 1 ) … ( p - ( s - 1 ) )}{( \begin{matrix}k \\ {i}_{1}\end{matrix} ) ( \begin{matrix}k - {i}_{1} \\ {i}_{2}\end{matrix} ) … ( \begin{matrix}k - ( {i}_{1} + … + {i}_{s - 1} ) \\ {i}_{s}\end{matrix} )} \\ = O ( {p}^{k} / k ! ) .\end{matrix}$$

Now, consider the set of k-products

$${S}_{k}^{′} = \{ {\prod }_{i = 1}^{k} {v}_{i} : v = [ {v}_{1} , … , {v}_{k} ] ∈ {V}_{k} \} .$$

Clearly, Sₖ=S′ₖ and |S′ₖ|≤|Vₖ|. In general, the size of S′ₖ will be strictly less than the size of Vₖ if there exists a pair υ,w∈Vₖ such that υ≠w in Vₖ but Πυᵢ=Πw_{υ}. For example, if α,β, γ∈ [symbol] ₚ* are pairwise distinct, then setting υ₁=w₁=α_{σ}, υ₂=β_{σ}, υ₃=(−β)_{σ}, w₂=γ_{σ}, and w₃=(−γ)_{σ} yields such a pair. In fact, the number of distinct elements υ∈Vₖ which lead to the same k-product as exactly in this example can be estimated as O(p^{k-1}/k!). It seems like a hard problem to classify all tuples υ∈Vₖ which lead to the same k-product in [symbol] . However, one can make the heuristic assumption that their number is captured in our previous estimate O(p^{k-1}/k!). Therefore, one can estimate that |Sₖ|=O(p^{k}/k!). The estimate |Sₖ|=O(p^{k}/k!) can also be justified by another counting argument because there are roughly p choices for each term vᵢ in the k-product Πᵢ₌₁^{k}υᵢ, and permuting vᵢ's does not change the value of the product. Now, assuming the elements of Sₖ are uniformly distributed over [symbol] and recalling that, | [symbol] |=p^{m}+1 it is expected for about p^{k}/k! elements in [symbol] to have a unique k-decomposition for k≤m. Similarly, it is expected for about all elements in [symbol] to have p^{k-m}/k! distinct k-decompositions for k>m. The heuristic argument is further justified by the nature of the linear system of equations obtained in the k-decomposition procedure because the system has m equations and k variables over [symbol] ₚ. It should be noted that similar heuristics and estimates have been discussed in the context of elliptic curve groups.

PROJECT AND DECOMPOSE. NTT-Sec consists of two algorithms: Proj (Project) and Decomp (Decompose). The algorithm Proj extracts a noise tolerant and secure template tₓ of a sensitive data x. Proj represents the operation of a class 3 component, as discussed above. The noise tolerance of the construction follows from Decomp that determines whether two templates tₓ and t_{y} originate from x, y∈{0, 1}ⁿ with d(x, y)≤e for some priori-fixed error tolerance bound e. As already noted above, one assumes that x, y∈{0, 1}ⁿ are binary strings of length n for some positive integer n, and d(x,y) denotes the Hamming distance between x and y. In other words, the noise tolerance of the construction follows from Decomp such that given a pair of templates, Decomp can determine whether the first data corresponding to the first template lies within the priori-chosen noise tolerance bound of the second data corresponding to the second template. The security of this scheme is discussed in further detail below.

The Proj Algorithm.

Consider the family of all functions Φ={ϕ: {0, 1}ⁿ→{ [symbol] ₚ}ⁿ}, where each is a function from the set of binary strings of length n to the set of [symbol] ₚ-strings of length n. For x=(x₁, x₂, . . . , xₙ)∈{0, 1}ⁿ, one denotes the i'th coordinate of ϕ(x)∈{ [symbol] ₚ}ⁿ by [ϕ(x)]ᵢ, and define Proj_{ϕ}: {0, 1}ⁿ→ [symbol] as follows:

$${Proj}_{φ} ( x ) = {\prod }_{i = 1}^{n} {( {[ φ ( x ) ]}_{i} )}_{σ} = {\prod }_{i = 1}^{n} \frac{{[ φ ( x ) ]}_{i} + σ}{{[ φ ( x ) ]}_{i} - σ}$$

Theorem 1: Let ψ* andProj be as defined above. Let ψ*⊂ψ be a subfamily of functions such that

Φ*={ϕ_{{g}_{ᵢ}_{}}_{ᵢ₌₁}ₙ:ϕ_{{g}_{ᵢ}_{}}_{ᵢ₌₁}ₙ∈Φ,gᵢ∈ [symbol] ₚ,[ϕ_{{g}_{ᵢ}_{}}_{ᵢ₌₁}ₙ(x)]ᵢ=(−2xᵢ+1)gᵢ}.

### Then

$${Proj}_{{φ}_{{\{ {g}_{i} \}}_{i = 1}^{n}}} ( x ) = {\prod }_{i = 1}^{n} {( {g}_{i} )}_{σ}^{( - 2 {x}_{i} + 1 )} .$$

The algorithm Proj is in the basis of extracting noise tolerant and secure template tₓ of a sensitive data x∈{0, 1}ⁿ. A set of concrete parameters are proposed and specify exactly how to derive tₓ from x. Let n and e be two positive integers such that n>2e, where e represents the error tolerance bound. Let p >2n be a prime number, q=p^{m} and with m=2e. As before, [symbol] denotes the order-(q+1) subgroup of [symbol] _{q}_{²}*, where [symbol] _{q}_{²}= [symbol] _{q}[σ]/ [symbol] ²−c [symbol] and c∈ [symbol] _{q} is a quadratic non-residue. Let {gᵢ}ᵢ₌₁ⁿ be a sequence of pairwise distinct elements in [symbol] ₚ* with the additional property that −gⱼ∉{gᵢ}ᵢ₌₁ⁿ for all j=1, . . . , n. One example of such a sequence is {gᵢ}ᵢ₌₁ⁿ={i}ᵢ₌₁ⁿ. The rest of this section assumes that parameters are set as just described.

Computing a Secure Template.

For some fixed choice of {gᵢ}ᵢ₌₁ⁿ (as described above), one can let ϕ*=ϕ{gᵢ}ᵢ₌₁ⁿ∈ψ*, and the template of is defined such that

$${Proj}_{{φ}^{*}} ( x ) = {( {t}_{x} )}_{σ} = \frac{{t}_{x} + σ}{{t}_{x} - σ}$$

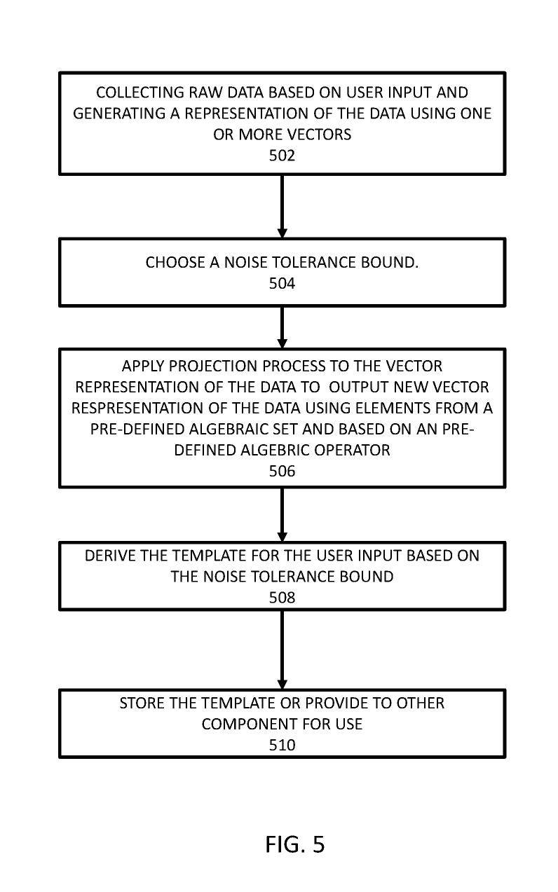

Functionally, the use and operation of the Proj algorithm to generate a secure and noise-tolerant template can be summarized as follows and as shown in FIG. 5:
a. Collecting raw data of interest and providing a representation of the data of interest as either a single vector or as a collection of vectors or matrix of vectors, where each vector consists of vector components or digits (502). Choosing a noise tolerance bound to be used to indicate an amount of noise that can be tolerated while acquiring biometric or any type of data, say through one or many components in Class 1 (504). In some implementations, the noise tolerance bound can be pre-defined and used for certain application or a default noise tolerance bound may be provided.
b. Apply a projection process (506) to compute a transformation of the data (in vector form) by mathematically combining elements (i.e., digits or components) in the vectors of its representation, where the projection function performs this transformation as a function of the noise-tolerance bound, and where the projection function is configured to take the vector representation of data as input and outputs an element in an algebraic set by:
   i. Defining a set such that the vector components or digits in the representation of the data belong to this set.
   ii. Defining an algebraic set with an algebraic operator. Alternatively, a group and a group operator can be defined.
   iii. Defining and applying a mapping function that takes the vector representation of data as input and maps it to a new vector where the elements (i.e., vector components or digits) of this new vector belong to the algebraic set.
   iv. Yielding as the output of the projection process an element in the algebraic set by mathematically combining the vector components of the output of the mapping function via the algebraic operator.
c. Derive the template of a data from the given projection of the data as a function of the noise-tolerance bound (508).
d. Store the template in the database (without or without an identifier) or provide the template to a component for use (e.g., comparing with another template) (510).
   Optionally, a randomization procedure or process can be applied. In such configurations, the projection process would also include:
a. Defining a randomization set.
b. Applying a randomization procedure, based on the randomization set, to the mapping function so that the vector representation of the input data is mapped to a new randomized vector where the vector components or digits of this new vector belong to the algebraic set.

The Decomp Algorithm.

The decomposition algorithm Decomp returns a number between 0 and e if two secure templates tₓ and t_{y} originate from x, y∈{0, 1}ⁿ with d(x, y)≤e. Otherwise, the return value is −1 Here, ϕ*=ϕ{gᵢ}ᵢ₌₁ⁿ and {gᵢ}ᵢ₌₁ⁿ is chosen as described above during template extraction. Decomp takes tₓ,t_{y} as input (in addition to the other system parameters, {gᵢ}ᵢ₌₁ⁿ, [symbol] [symbol] _{q}_{²}= [symbol] _{q}[σ]/ [symbol] σ²−c [symbol] , and runs as follows:
1. If tₓ=t_{y}, then return 0.
2. If tₓ≠t_{y}, then compute t_{z}∈ [symbol] _{q} such that

(t_{z})_{σ}=(tₓ)_{σ}/(t_{y})_{σ}.
3. For k=1, . . . , e, perform the k-decomposition algorithm on (tₓ)_{σ} and if (t₂)_{σ} is found to be 2 k-decomposed for some k=1, . . . , e such that

$${( {t}_{z} )}_{σ} = \frac{{t}_{z} + σ}{{t}_{z} - σ} = {\prod }_{j = 1}^{k} {( \frac{{α}_{j} + σ}{{α}_{j} - σ} )}^{2} , \qquad ( 4 )$$

and αⱼ∈{gᵢ}ᵢ₌₁ⁿ∪{−gᵢ}ᵢ₌₁ⁿ for all j=1, . . . , k, then return k. Otherwise, return −1.

### Correctness of Decomp.

Suppose that tₓ and t_{y}, originate from x, y∈{0, 1}ⁿ with d(x, y)=e′. That is, (tₓ)_{σ}=Proj_{ϕ*}(x) and (t_{y})_{σ}=Proj_{ϕ*}(y). If e′=0, then clearly tₓ=t_{y}, and Decomp returns 0 as required. Now, suppose e′≥1. One can write

$$\begin{matrix}{( {t}_{z} )}_{σ} = \frac{{( {t}_{x} )}_{σ}}{{( {t}_{y} )}_{σ}} \\ = \frac{{Proj}_{{φ}^{*}} ( x )}{{Proj}_{{φ}^{*}} ( x )} \\ = \frac{{\prod }_{i = 1}^{n} {( {g}_{i} )}_{σ}^{( - 2 {x}_{i} + 1 )}}{{\prod }_{i = 1}^{n} {( {g}_{i} )}_{σ}^{( - 2 {y}_{i} + 1 )}} \\ = {\prod }_{i = 1}^{n} {( {g}_{i} )}_{σ}^{2 ( {y}_{i} - {x}_{i} )} \\ = {\prod }_{{i = 1}_{{{y}_{i} \neq {x}_{i}}_{{y}_{i} = 1}}}^{n} {( {g}_{i} )}_{σ}^{2} {\prod }_{{i = 1}_{{{y}_{i} \neq {x}_{i}}_{{x}_{i} = 1}}}^{n} {( - {g}_{i} )}_{σ}^{2} \\ = {\prod }_{j = 1}^{{e}^{′}} {( \frac{{α}_{j} + σ}{{α}_{j} - σ} )}^{2} ,\end{matrix}$$

where αⱼ∈{gᵢ}ᵢ₌₁ⁿ∪{−gᵢ}ᵢ₌₁ⁿ for all j=1, . . . , e′. Therefore, if e′≤e, then the 2 k-decomposition of (tₓ)_{σ} will be of the desired form for k=e′, and Decomp will return k=e′ Otherwise, if e′>e, Decomp will return −1 unless the decomposition procedure still finds a 2 k-decomposition for some 1≤k≤e. However, the chances of a failure are very slim because even if (tₓ)_{σ} has a 2 k-decomposition, then the decomposition is expected to be unique, whence unlikely to be of the very particular form. More precisely, one can estimate the failure probability as

$$O ( {\sum }_{k = 1}^{e = m / 2} \frac{{p}^{2 k} / ( 2 k ) !}{{p}^{m}} \frac{{p}^{k} / k !}{{p}^{2 k} / ( 2 k ) !} ) = O ( \frac{1}{{p}^{m / 2} ( m / 2 ) !} )$$

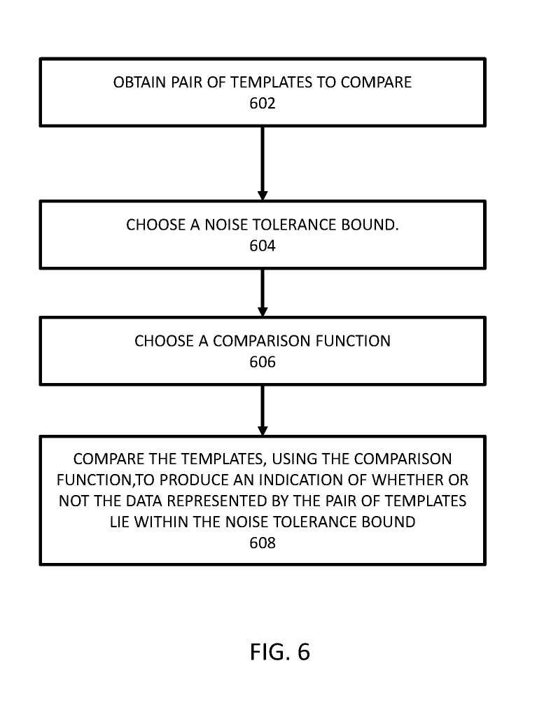

Functionally, the use and operation of the Decomp algorithm to determine a similarity measure between a pair of data, where the input to this method is a pair of secure and noise tolerant templates generated according to the Proj algorithm, can be summarized as follows and as shown in FIG. 6:
1. Obtaining the pair of templates corresponding to the pair of data (602).
2. Choosing a noise (error) tolerance bound (604). In some implementations, the noise tolerance bound can be pre-defined and used for certain application or a default noise tolerance bound may be provided.
2. Choosing a comparison (i.e., a similarity or distance) function (606). In some implementations, the comparison function can be pre-defined and used for certain application or a default comparison function may be provided.
3. Comparing the templates (608), by performing a computational decomposition procedure such that given the first template of the pair and the second template of the pair, to produce an indication of whether or not the first input data represented by the first template lies within the noise tolerance bound of the second input data that corresponds to the second template with respect to the similarity/distance function.
   In this process, the computational decomposition procedure can be summarized as:
1. Directly comparing the two secure templates in the input pair;
2. If the two secure templates are identical, then outputting a similarity measure indicating that the distance between the first input data and the second input data is zero, or alternatively, indicating that the first input data and the second input data are from a same source or otherwise equivalent.
3. if the two secure templates are not identical then:
   a. Deriving an element in an algebraic set (or group) as a mathematical function of the two secure templates, where the algebraic set corresponds to that utilized during the Proj Algorithm.
   b. Decomposing the element as a product of elements in the algebraic set, where the product of elements are defined using the algebraic (or group) operator for the algebraic set.
   c. If all the factors in the product of elements belong to a particular subset and priori-defined subset of the algebraic set, then outputting a similarity measure indicating that the first input data lies within the noise tolerance bound of the second input data.
   d. If some of the factors in product of elements do not belong to the particular and priori-defined subset of the algebraic set, then outputting a similarity measure indicating that the first input data does not lie within the noise tolerance bound of the second input data.
      In the case that the optional randomization is applied in the Proj algorithm to generate the templates being compared, the methodology above can be configured accordingly to determine a similarity measure between a pair of data given their randomized templates. A particular implementation of this process is discussed below in greater detail.

One can also mathematically summarize the Proj algorithm (template extraction) and the Decomp algorithm (comparison) as follows:

Algorithm 1 Projection algorithm: Proj

```
Input: x ϵ {0,1}ⁿ, p, n, e, q = p^{m}, G ⊂ F_{q}_{²}^{^{*}}
Output: tₓ ϵ F_{q}
  Choose {gᵢ}ᵢ₌₁ⁿ and let ϕ* = ϕ_{{g}_{ᵢ}_{}}_{ᵢ₌₁}^{ₙ} ϵ Φ*
  $Compute {Proj}_{ψ} \cdot ( x ) = \frac{{t}_{x} + σ}{{t}_{x} - σ}$
  return tₓ ϵ F_{q}
```

Algorithm 2 Decomposition algorithm: Decomp

```
Input: tₓ, t_{y} ϵ F_{q}, p, n, e, q = p^{m}, G ⊂ F_{q}_{²}^{^{*}}, {gᵢ}ᵢ₌₁ⁿ as in Algorithm [symbol]
Output: −1 or k such that 0 ≤ k ≤ e
  if tₓ = t_{y} then
    return 0
  else
    $Compute \frac{{t}_{x} + σ}{{t}_{x} - σ} = ( \frac{{t}_{x} + σ}{{t}_{x} - σ} ) {( \frac{{t}_{y} + σ}{{t}_{y} - σ} )}^{- 1}$
    $For k = 1 , … , e perform the k - decomposition algorithm on \frac{{t}_{x} + σ}{{t}_{x} - σ}$
    $if All factors in the decomposition belong to {\{ \frac{{g}_{i} + σ}{{g}_{i} - σ} \}}_{i = 1}^{n} ⋃ {\{ \frac{- {g}_{i} + σ}{- {g}_{i} - σ} \}}_{i = 1}^{n} then$
      return k
    else
      return −1
    end if
  end if
```

Security of the New Construction

The security of NTT-Sec can be discussed with respect to irreversibility and indistinguishability of templates. In the following, system parameters will be denoted by the set

SP={p,n,e,q=p^{m}, [symbol] ⊂ [symbol] _{q}_{²},ϕ*={gᵢ}ᵢ₌₁ⁿ}

One can first formally model the irreversibility and indistinguishability of a template by the following games between a challenger C and an adversary A. One can assume that A is provided with SP and the explicit definitions of the algorithms Proj and Decomp. A is assumed to be computationally bounded.

Irreversibility Game G_{IRR}:

The challenger C chooses x∈{0, 1}ⁿ uniformly at random, computes the template tₓ of x, and sends tₓ to A. A outputs y⊂{0, 1}ⁿ and wins if d(x,y)≤e. Here, our motivation for having d(x,y)≤e (rather than y=x) is that Algorithm 2 returns Match when comparing tₓ against y with d(x,y)≤e.

Indistinguishability Game G_{IND}:

The challenger C chooses two different sets of system parameters SP₁ and SP₂. C chooses x∈{0, 1}ⁿ uniformly at random, computes the template tₓ of x with respect to SP₁, and sends tₓ to A. Next, C selects b∈{0, 1} uniformly at random. If b=1, then C chooses y∈{y∈{0, 1}ⁿ: d(x, y)≤e} uniformly at random. If b=−0, then C chooses y∈{y∈{0, 1}ⁿ: d(x, y)>e} uniformly at random. C computes the template t_{y} of y with respect to SP₂ and sends it to the attacker A. A outputs b′ and wins if b′=b.

The above-described modeling of the irreversibility and indistinguishability notions are similar to the ones described in K. Simoens, P. Tuyls, and B. Preneel. “Privacy Weaknesses in Biometric Sketches.” Security and Privacy, 2009 30th IEEE Symposium on Security and Privacy, pages 188 (203, 2009. (Simoens) but different in the following ways. The irreversibility game defined in Simoens by Gᵢᵣᵣ, can be adapted to this setting as follows. The challenger C chooses two different sets of system parameters SP₁ and SP₂. C chooses x∈{0, 1}ⁿ uniformly at random, computes the template tₓ of x with respect to SP₁, and sends tₓ to A. Next, C chooses y∈{y∈{0, 1}ⁿ: d(x, y)>e} uniformly at random, computes the template tₓ of x with respect to SP₂, and sends t_{y} to A. A outputs z and wins if z=x. Further, the breaking the security of NTT-Sec with respect to the indistinguishability notion is not harder than breaking the security of NTT-Sec with respect to the irreversibility notion in Simoens (i.e. if NTT-Sec is secure with respect to our indistinguishability notion, then NTT-Sec is secure with respect to the irreversibility notion in Simoens). Let A be an adversary who plays the game G_{IND}, and suppose there is an adversary A′ with success probability pₛ in Gᵢᵣᵣ. Based on what A receives from C in the game G_{IND}, A plays the role of a challenger in Gᵢᵣᵣ and initiates the game with A′. Suppose that A′ outputs z in Gᵢᵣᵣ. Then A computes t_{z} and runs Decomp with input t_{z} and t_{y}. A outputs b′=1 in G_{IND} if and only if Decomp returns a number between 0 and e. If A′ halts in Gᵢᵣᵣ without outputting any value z, A outputs b′=0 in G_{IND}. Finally, the success probability Pr[b′=b] of A is

$$Pr ( b = 1 ) Pr ( {b}^{′} = 1 \vert b = 1 ) + Pr ( b = 0 ) Pr ( {b}^{′} = 0 \vert b = 0 ) = \frac{{p}_{s}}{2} + \frac{1}{2} .$$

This finishes the proof because A's advantage over random guessing in G_{IND} is pₛ/2, which is a polynomial function of A's success probability pₛ in Gᵢᵣᵣ.

The indistinguishability game defined in Simoens by G_{ind}, can be adapted to this setting as follows. The challenger C chooses a single set of system parameters SP, and sends it to the attacker A. C chooses x∈{0, 1}ⁿ uniformly at random, computes the template tₓ of x with respect to SP, and sends tₓ to A. Next, C selects b∈{0, 1} uniformly at random. If b=1, then C chooses y∈{y∈{0, 1}ⁿ: d(x, y)≤e} uniformly at random. If b=0, then C chooses y∈{y∈{0, 1}ⁿ: d(x, y)>e} uniformly at random. A outputs b′ and wins if b′=b.

It should be clear that breaking the security of NTT-Sec with respect to the indistinguishability notion in Simoens is not harder than breaking the security of NTT-Sec with respect to the indistinguishability notion described herein. In fact, an adversary A can have non-negligible advantage in attacking NTT-Sec with respect to G_{ind} by simply outputting b′=1 when Decomp returns a number between 0 and e on the input pair tₓ,t_{y}; and b′=0, otherwise. Moreover, the success probability of A in attacking NTT-Sec with respect to G_{ind} is

$$\frac{1}{2} ( 1 - FR ) + \frac{1}{2} ( 1 - FA ) = 1 - \frac{FA + FR}{2} ,$$

where FA and FR are the false acceptance and false reject rates of NTT-Sec. This attack strategy is likely to apply generically to other deterministic schemes, too. Therefore, a probabilistic (randomized) versions of NTT-Sec can be used to circumvent such attacks.

The security of NTT-Sec can also be analyzed in view of some generic and sophisticated attacks.

Irreversibility

Guessing Attack:

A guesses some y∈{0, 1}ⁿ at random and outputs y in the game G_{IRR}. One can estimate the winning probability of A with this strategy to be Σᵢ₌₀^{e}(ᵢⁿ)/2ⁿ. A can increase her chances in winning the game G_{IRR} by running Algorithm 2 with input tₓ and t_{y}, and verifying whether d(x,y)≤e. This type of dictionary attack can be prevented using a probabilistic (randomized) version of NTT-Sec.

Brute Force Attack:

A exhaustively searches for a fixed number of bits in x, and tries to recover x by running the k-decomposition procedure discussed above. More concretely, A fixes the first (n-k) indices and computes

$${( {t}_{x , k} )}_{σ} = {\prod }_{i = 1}^{n - k} {( {g}_{i} )}_{σ}^{- 2 {x}_{i}^{′} + 1}$$

for an ordered sequence {xᵢ′}ᵢ₌₁^{n-k} with xᵢ′∈{0, 1}. Then A computes the set of k-decompositions of (t_{x′})_{σ}=(tₓ)_{σ}/(t_{x,k})_{σ}. A repeats this procedure (by varying {xᵢ′}ᵢ₌₁^{n-k}) until a particular decomposition

$${( {t}_{{x}^{′}} )}_{σ} = {\prod }_{i = 1}^{k} {( {α}_{i} )}_{σ} , {α}_{i} ∈ {𝔽}_{p} ,$$

where αᵢ∈{gₙ₋ₖ₋ᵢ, −gₙ₋ₖ₋ᵢ} for all i=1, . . . , k, is found. Consequently, A can recover x. Based on 1^{st} conjecture above, one can estimate the number of k-decompositions A needs to perform (for a non-trivial success probability) to be 2^{n-k} max(1, p^{k-m}/k!) for m<k≤n; and 2^{n-k} for k≤m. Since decompositions are performed in polynomial time, A would need to perform at least 2^{n-m} decompositions asymptotically.

Discrete logarithm attack: Let g∈ [symbol] be a generator of the cyclic group [symbol] Suppose that (gᵢ)_{σ}=g^{e}^{ᵢ} and (tₓ)_{σ}=g^{t}, where eᵢ, t∈[1, | [symbol] |]. Recall that (tₓ)_{σ}=Πᵢ₌₁ⁿ(gᵢ)_{σ}^{-2x}^{ᵢ}⁺¹ and so

g^{t}=gΣᵢ₌₁ⁿ(−2xᵢ+1)eᵢ

which implies

$$t ≡ {\sum }_{i = 1}^{n} ( - 2 {x}_{i} + 1 ) {e}_{i} mod \vert 𝔾 \vert . \qquad ( 5 )$$

Therefore, given (tₓ)_{σ} and {gᵢ}ᵢ₌₁ⁿ, the adversary A can fix a generator g∈ [symbol] and compute the discrete logarithms eᵢ and t of (gᵢ)_{σ} and (tₓ)_{σ}, respectively. Then, A can solve the modular {−1,1}-Knapsack problem over the set {e₁, . . . , eₙ} with the target element t, whence determine each xᵢ. Assuming the cost of computing the discrete logarithm of an element in a group [symbol] is C_{DLP}, and the cost of solving the above mentioned modular Knapsack problem is C_{Knapsack}, the cost of this attack is estimated to be (n+1)C_{DLP}+C_{Knapsack}. In this setting, discrete logarithms are to be computed in the field [symbol] _{Q}, where Q=p^{4e}, and [symbol] _{Q} has typically small characteristic (i.e. p=ln Q^{O(1)})). The best known algorithm (under the plausible assumption that [symbol] does not succumb to Pohlig-Hellman type attacks, guaranteed by choosing [symbol] such that its order is nearly prime) to solve the discrete logarithm problem in such fields runs in quasi-polynomial time 2^{O(l̆n ln Q)2}. Due to the potential low density n/(m log₂ p)| of the underlying Knapsack problem for practical parameters, one can anticipate that C_{Knapsack} will be negligible compared to C_{DLP} and estimate the cost of this discrete logarithm attack to be (n+1)2^{(ln lnQ)}^{^{2!}}.

In the following, further formalized is the relationship between the irreversibility of templates and the difficulty of the discrete logarithm problem DLP [symbol] in [symbol] (i.e. given a generator g∈ [symbol] and a second element h∈ [symbol] , compute an integer a such that h=g^{a}). Theorem 2 below provides further assurance on the irreversibility of templates especially when NTT-Sec is instantiated with an appropriate choice of [symbol] in which DLP is known to be intractable.

Theorem 2: Let SP={p, n, e, q=p^{m}, [symbol] ⊂ [symbol] _{q}_{²}, ϕ*={gᵢ}ᵢ₌₁ⁿ} such that 2ⁿ/p^{m}=1. Assume that S={Πᵢ₌₁ⁿ gᵢ^{T}^{ᵢ}: rᵢ∈{−1, 1}} is uniformly distributed in [symbol] . If there is an adversary A that wins the game G_{IRR} in polynomial time, then there is an adversary A′ that can solve DLP [symbol] polynomial time.

In setting Theorem 2, winning the game G_{IRR} may be strictly harder than solving DL [symbol] because from the discussion of the discrete logarithm attack, it seems like the adversary also has to solve a knapsack problem with density n/(mlog₂p)≈1. Knapsack problems with density close to 1 are known to belong to the hardest class of knapsack problems. The best known algorithms for solving such knapsack problems are generic and run in exponential time.

Indistinguishability

Cross Correlation Attack:

In order to model a strong adversary in the game G_{IND}, one can assume that SP₁ are SP₂ are exactly the same except that tₓ and t_{y} are constructed via Proj using distinct {gᵢ}ᵢ₌₁ⁿ and {hᵢ}ᵢ₌₁ⁿ, respectively. In the attack strategy that one can consider, A computes (t_{x,y})_{σ}=(tₓ)_{σ}/(t_{y})_{σ}, and analyze k-decompositions of (t_{x,y})_{σ} for k=1, . . . , 2e. Consider an extreme case, where gᵢ and hᵢ differ only at the last index i=n. Then A would have significant advantage in G_{IND} because if d(x,y)≤e, then (t_{x,y})_{σ} would have a particular k-decomposition of the form

$${\prod }_{j = 1}^{k} {( {v}_{j} )}_{σ} , {v}_{j} ∈ {\{ \pm {g}_{i} \}}_{i = 1}^{n} ⋃ {\{ \pm {h}_{i} \}}_{i = 1}^{n}$$

for some 1≤k≤2e. Otherwise, if d(x,y)>e, the elements vⱼ in the k-decomposition of (t_{x,y})_{σ} are expected to be randomly distributed over the elements of [symbol] ₚ. On the other hand, if {±gᵢ}ᵢ₌₁ⁿ and {hᵢ}ᵢ₌₁ⁿ are disjoint or the size of their intersection is small, then this attack strategy does not seem to help A because the elements vⱼ in the decomposition of (t_{x,y})_{σ} are expected to be randomly distributed over the elements of [symbol] ₚ independent of the distance between x and y. In general, it is natural to deploy our scheme over different systems such that the algorithm Proj is instantiated with different parameters including the choice of different primes p, field extension polynomials, and ϕ*={gᵢ}ᵢ₌₁ⁿ. In this general case, recovering x and y from tₓ and t_{y} seems to be the only useful attack strategy for A to distinguish whether d(x,y)≤e (i.e. A has to play the irreversibility game G_{IRR}).

Implementation Results

In order to show the efficiency of the NTT-Sec scheme and to be more concrete on the security analysis, the implementation results of the scheme are reported with with realistic parameters. The parameters are chosen to match the implementation of a fingerprint biometric authentication scheme with a fixed length representation of biometric data. In particular, an implementation that creates a secure template tₓ of a biometric data x∈{0, 1}⁵¹¹, where a linear BCH-code with parameters (n,k,t)=(511,76,85) is deployed. A secure template tₓ is matched against y if and only if d(x,y)≤585 with a reported equal error rate of 0.05. Therefore, the parameters were set as n=511, e=85, m=2e, p≈2¹², and q=p^{m}. {gᵢ}ᵢ₌₁ⁿ={i}ᵢ₌₁ⁿ was also set. This scheme was implemented using C++ on a desktop computer (Intel® Xeon® CPU E31240 3.30 GHz). 10 pairs (x,y) of binary strings were created with of length 511 with d(x,y)≤e and 10 pairs (x,y) were created with with d(x,y)>e. The average time for creating a secure template tₓ is 0.1 seconds, and the average time for matching a secure template tₓ against y is 0.35 seconds. The secure template tₓ is an element in [symbol] ₚ_{^{m}} and hence log₂p^{m}≈2089-bits are required to store tₓ. Based on the discussion above, one can estimate that this scheme offers 72-bit security because

$$min ( {2}^{n} / {\sum }_{i = 0}^{ϵ} ( \begin{matrix}n \\ i\end{matrix} ) , {2}^{n - k} max ( 1 , {p}^{k - m} / k ! ) {\vert}_{ m < k \leq n} , {2}^{n - k} {\vert}_{k \leq m} , ( n + 1 ) {2}^{{( l nl n {p}^{2 m} )}^{2}} ) \approx {2}^{72} .$$

Security Enhancements and Comparisons

Comparison.

The new scheme described above compares favorably with code-based implementation in other existing schemes. For example, the security of the new scheme with the above-mentioned proposed parameters is estimated to be 72-bits. Other implementations (with a (511,76,85) BCH-code) can offers 76-bit security against the brute force attack. As already discussed above, linear error correcting code based schemes in general fail to satisfy indistinguishability and irreversibility properties under reasonable and practical attack models. The main idea in these attacks is to manipulate the linearity of the underlying operations, as discussed on Simoens. These attack ideas do not seem to apply to the new scheme when system parameters are appropriately chosen.

Flexibility.

The new scheme also has a flexible setting for system parameters that offers various security levels and trade-offs. If the length of data and the error tolerance bound are fixed, then the security level can be increased by choosing larger values for p. For example, changing the value of p from a 12-bit prime to 30-bit prime increases the security level from 72 to 87-bits at a cost of increasing the template length from 2089 to 5222-bits. On the other hand, increasing the security level in code-based schemes may not always be possible due to the limited range of code parameters. For example, increasing the security of some existing schemes from 76-bits (for biometric data of length 511) can require to use a (511,k,t) BCH-code with k>76. One natural choice is the (511,85,63) BCH-code, which comes at a cost of decreasing the error tolerance bound from 85 to 63 and hence results in worse false accept/reject rates in the implementation.

Enhancements.

The security of the new scheme described herein can be enhanced by declaring some of the system parameters as secret (and still assuming that the secure templates and the rest of the parameters are public). For example, in the brute force attack and the discrete logarithm attack, one assume that the attacker knows {gᵢ}ᵢ₌₁ⁿ. In the case {gᵢ}ᵢ₌₁ⁿ is secret, the best strategy for an attacker seems to exhaustively search for the correct sequence {gᵢ}ᵢ₌₁ⁿ. Therefore, one can estimate that the costs of the brute force and the discrete logarithm attacks are multiplied by a factor Πᵢ₌₀ⁿ⁻¹ (p−(2i+1))| (recall that gᵢ∈ [symbol] ₚ are non-zero, pairwise distinct, and −gⱼ∉{gᵢ}ᵢ₌₁ⁿ for all j=1, . . . , n). In this case, the security level of the new scheme with the proposed parameters described above is estimated to increase from 72-bits to 183-bits, where the guessing attack seems to be the best attack strategy.

As discussed above, one can formalize the security impact of having private system parameters and show that, without the knowledge of {gᵢ}ᵢ₌₁ⁿ, the template tₓ of a data x∈{0, 1}ⁿ is not likely to leak any information about x.

Theorem 7.1 Let tₓ be the secure template of x∈{0, 1}ⁿ such that

$${( {t}_{x} )}_{σ} = {Proj}_{{φ}_{{( {θ}_{i} )}_{i = 1}^{n}}} ( x )$$

for some ϕ_{{g}_{ᵢ}_{}}_{ᵢ₌₁}ₙ ∈Φ*. For any y∈{0, 1}ⁿ, there is a choice of ϕ_{{h}_{ᵢ}_{}}_{ᵢ₌₁}ₙ ∈Φ* such that

$${Proj}_{{φ}_{{\{ {h}_{i} \}}_{i = 1}^{n}}} ( y ) .$$

Randomization.

As noted earlier, it can be desirable to have a randomized template extraction algorithm. One naive adaptation would be to replace the template tₓ of x in the database by (tₓ⊕E_{K}(r),r), where r is a random binary string, and E_{K} is a keyed pseudorandom function or an encryption function, such that the key K is only known to the database. Here, one can use a randomization technique.

One can define

$${Proj}_{{φ}^{*}} ( x , r ) = {\prod }_{i = 1}^{n} {( {g}_{i} )}_{σ}^{( - 2 {x}_{i} + 1 ) {r}_{i}} ,$$

where r=(r₁, r₂, . . . , rₙ) is a randomly chosen string with rᵢ∈{−1, 1}. The template of x is then defined by the pair (t_{x,r},r), where

(t_{x,r})_{σ}=Proj_{ϕ*}(x,r),t_{x,r}∈ [symbol] _{q}.

It is straightforward to modify Algorithm 1 and Algorithm 2 accordingly. One can also show that the randomized template of data x∈{0, 1}ⁿ is not likely to leak any information about x.

Extending NTT-SEC for More Generic Data

One of the assumptions in the implementation of NTT-Sec, as described above, is that noisy data is represented by a fixed length binary string. This assumption may be too strong to be realized in certain practical implementations. For example, it is very unlikely that the minutiae point sets of a fingerprint are ever of the same length through measurements at different times. Therefore, the present disclosure contemplates that the methods described herein can be adapted for other biometrics such as iris, face, palm, etc. based authentication and identification systems; or they can be adapted for other authentication and identification systems that require noise-tolerance with applications in location-based services (i.e. finding nearby restaurants and friends) and social media services (i.e. friend-matching).

Setting and Parameters.

One can start by assuming that distinctive characteristics of a fingerprint are represented by a variable length ordered set of minutiae points

M={M(i)=(x(i),y(i),θ(i))}ᵢ₌₁^{k},

where x(i), y(i), and θ(i) represent the x-coordinate, y-coordinate, and the angle of the minutiae M(i). Once can then define the following variables as part of the parameters to be used in the algorithms as:

1. s₁, s₂, s₃, and c are scaling factors.

2. n is the number of neighbours.

3. p>3·c·n is a prime power.

4. e and b are error tolerance bounds.

5. q=p^{e}, and [symbol] _{q} is a finite field with q elements, and [symbol] _{q}_{²} is a finite field with q² elements.

Extracting a Local Data Set from the Minutiae Set.

Next, the present disclosure turns to a method to create a local data set given the minutiae set M={M(i)}ᵢ₌₁^{k}. For each minutiae point M(i), one can determine the neighbour set

N(i)={Nⱼ(i)=(xⱼ(i),yⱼ(i),θⱼ(i))}ⱼ₌₁ⁿ,

where xⱼ(i), yⱼ(i), and θⱼ(i) represent the x-coordinate, y-coordinate, and the angle of the minutiae Nⱼ(i). The neighbours Nⱼ(i) for j=1, . . . , n are chosen from the minutiae set M\M(i) such that the distance dⱼ(i) between M(i) and Nⱼ(i) are minimum among all possible distances between all pairs of minutiae points. One can then define aⱼ(i) to be the angle between the two lines l₁ and l₂, where l₁ is the line that passes through (x(i),y(i)) and (xⱼ(i),yⱼ(i)) and l₂ is the line that passes through (x(i),y(i)) in the direction of θ(i). One can also define βⱼ(i) to be the relative angle between θ(i) and θⱼ(i). Consequently, each minutiae point M(i) is associated with a local sequence

L(i)=[d₁(i), . . . ,dₙ(i),α₁(i), . . . ,αₙ(i),β₁(i), . . . ,βₙ(i)].

The elements of the sequence L(i) may be reordered so that the values dⱼ(i), or αⱼ(i), or βⱼ(i) appear sorted. Then, the ordered sequence Lᵢ is scaled, and it yields

S(i)=[└d₁(i)/s₁┘, . . . ,└dₙ(i)/s₁┘,└α₁(i)/s₂┘, . . . ,└αₙ(i)/s₂┘,└β₁(i)/s₃┘, . . . ,└βₙ(i)/s₃]┘.

Finally, the local minutiae data set of M=(M(i))ᵢ₌₁^{k} is denoted by S={S(i)}ᵢ₌₁^{k}.

Comparing Local Minutiae Data Sets.

Let M={M(i)}ᵢ₌₁^{k} and M′={M′(i)}ᵢ₌₁^{l} be two minutiae sets with their respective local representations S=(S(i))ᵢ₌₁^{k} and S′={S′(i)}ᵢ₌₁^{l}. Also, let d(⋅,⋅) be a distance function defined on S(i) and S′(j). For example, if S(i)=[s₁(i), . . . , s₃ₙ(i)] and S′(j)=[s′₁(j), . . . , s′₃ₙ(j)], then one may define

$$d ( S ( i ) , {S}^{′} ( j ) ) = {\sum }_{t = 1}^{3 n} \vert {s}_{t} ( i ) - {s}_{t}^{′} ( j ) \vert .$$

One can then say that M and M′ match if

|{(i,j):d(S(i),S′(j))≤e,i=1, . . . ,k; j=1, . . . ,l}|≥b.

Otherwise, M and M′ do not match.

Secure Extraction and Comparison of Local Minutiae Data Sets.

Let M={M(i)}i=1 be a minutiae set. Let S={S(i)}ᵢ₌₁^{k} be the local minutiae data set of M, as constructed above. Let S(i)=[s₁(i), . . . , s₃ₙ(i)]. The noise tolerant secure template extraction (Proj) and comparison (Decomp) algorithms can be adapted to extract the secure template T={T(i)}ᵢ₌₁^{k} of S={S(i)}ᵢ₌₁^{k} (hence, the secure template of M={M(i)}ᵢ₌₁^{k}) as follows. For some fixed choice of {gᵢ}ᵢ₌₁ⁿ, as described above, one can let ϕ=ϕ_{{g}_{ᵢ}_{}}_{ᵢ₌₁}ₙ ∈Φ, and the template T(i)∈ [symbol] _{q} of S(i) is defined such that

$${Proj}_{φ} ( S ( i ) ) = {\prod }_{t = 1}^{3 n} {( {g}_{t} )}_{σ}^{{s}_{t} ( i )} = {( T ( i ) )}_{σ} = \frac{T ( i ) + σ}{T ( i ) - σ} .$$

The comparison between the two secure templates T and T′ of S and S′ can now be successfully performed (whether the given pair is a match or not) by adapting the algorithm Decomp defined above because, by construction of the parameters, f-decompositions (for f≤e) of (T(i))_{σ}/(T′(j))_{σ} with d(S(i),S′(i))≤e, can be distinguished from the f-decompositions of (T(i))_{σ}/(T′(j))_{σ} with d(S(i),S′(j))>e.

Extensions.

In general, secure comparison of minutiae sets can be performed by using other cryptographic mechanisms than those described above. For example, homomorphic encryption techniques can be used to securely compute d(S(i), S′(j)), and hence to conclude whether M and M′ match while preserving security and privacy. Moreover, the security of the new scheme described herein can also be enhanced by deploying multi-factor authentication ingredients such as combining several biometrics or passwords together with the noise-tolerance property.

A framework can also be defined to explain how to adapt new scheme in more general settings (i.e. to adapt our scheme to other biometrics-based authentication/identification schemes such as iris, face, palm, etc.; or to location-based services (i.e. finding nearby restaurants and friends) and social media services (i.e. friend-matching).
1. Let B be a data that belongs to a data space [symbol] . For example, B can be a particular biometric (i.e. fingerprint, iris, palm, etc.) that belongs to a space of biometrics [symbol] ; or B can be a particular configuration of answers to a quiz or survey, which belongs to a space [symbol] of all possible configuration of answers to a quiz or survey; or B can be a particular location that belongs to a space [symbol] of all possible locations.
2. Let M∈ [symbol] be a (digital or hard-copy) representation of a particular data [symbol] ∈ [symbol] . Here [symbol] is the space of all representations of all data in B, and one can define a representation function

r: [symbol] → [symbol] .
For example, M can be a minutiae representation of a fingerprint B; or M can be an ordered and digital encoding of answers given to a quiz or a survey; or M can be GPS-based encoding of a location B.
3. Let f: [symbol] → [symbol] = [symbol] ^{g}× [symbol] × . . . be a function from the space [symbol] of representations to a variable number of collections (or cross-products) of a data space D. For example, [symbol] , {0, 1}ⁿ can be the set of all ordered binary strings of length n; [symbol] = [symbol] ⁿ can be the set of all ordered integers of length n for some integer n.
4. Let sim: [symbol] ^{g}× [symbol] → [symbol] be a similarity function from D*×D* to a space [symbol] with some ordering relation ≤defined on [symbol] . For example, [symbol] can be the set of real numbers or integers with the usual ordering of real numbers or integers.
5. Given a pair B, B′∈ [symbol] ^{;}, one can declare that B and B′ match in [symbol] (or r(B)=M and r(B′)=M′ match in [symbol] ) if sim(f(r(B)),f(r(B′)))≥b for some priori-fixed error tolerance bound b∈ [symbol]
   In particular, the concrete example above can be seen as a particular instantiation of this framework as follows:
1. B is a fingerprint of a subject, B is a space of fingerprints.
2. M={(M(i)}ᵢ₌₁^{k} is a minutiae representation of B and r: [symbol] → [symbol] is a minutiae extraction function.
3. f: [symbol] → [symbol] is the function described above. Here, [symbol] = [symbol] ⁿ and n is an integer representing the number of minutiae neighbors in the local minutiae data set construction as described above.
4. Assume that r(B)=M=(M(i))ᵢ₌₁^{k}, r(B′)=M′=M′(i))ᵢ₌₁^{l}, and f(M)=S={S(i)}ᵢ₌₁^{k} ∈ [symbol] ^{k}=( [symbol] ³ⁿ)^{k}, f(M′)=S′={S′(i)}ᵢ₌₁^{l} ∈ [symbol] ^{l}=( [symbol] ³ⁿ)^{l}. The similarity function sim is defined such that

sim(S,S′)=|{(i:j):d(S(i),S′(j))≤e,i=1, . . . ,k; j=1, . . . ,l}|,

where e is some priori-fixed error tolerance bound as defined above.
5. Given a pair B, B′∈ [symbol] , one can declare that B and B′ match in [symbol] (or r(B)=M and r(B′)=M′ match in [symbol] ) if sim(f(r(B)),f(r(B′)))≥b for some priori-fixed error tolerance bound b∈ [symbol] .

Exemplary Implementation

Based on the foregoing discussions, the inventors have developed general methodologies for template generation and subsequent authentication/comparison of templates.

### Secure and Noise-Tolerant Template Generation.

Based on the foregoing, a general methodology of generating a secure and noise-tolerant template tₓ of data x can be provided, where x=(x₁, x₂, . . . , xₙ) has n digits and each xᵢ belongs to a set S. In one exemplary implementation, such a methodology can include the steps of:
(a) Choosing a number e, where 0≤e≤n, as the noise tolerance bound;
(b) Choosing a set S, a set [symbol] , and a function Proj such that:

$$Proj \text{:} \underbrace{S \times S \times … \times S}_{n copies} -> 𝔾$$

which can be evaluated at x=(x₁, x₂, . . . , xₙ); and
(c) Deriving a secure and noise-tolerant template tₓ from x and Proj(x).

The choosing of a set S, the set [symbol] , and a function Proj can generally involve:
(a) Choosing a set S such that each xᵢ∈S, a group [symbol] with group
operation ⊙, and a function ϕ such that one has:

$$φ \text{:} \underbrace{S \times S \times … \times S}_{n copies} -> \underbrace{𝔾 \times 𝔾 \times … \times 𝔾}_{n copies} ,$$

which can be evaluated on the data x=(x₁, x₂ . . . , xₙ₎, xᵢ∈S, as

ϕ(x)=ϕ((x₁,x₂, . . . ,xₙ))=([ϕ(x)]₁,[ϕ(x)]₂, . . . ,[ϕ(x)]ₙ).
where [ϕ(x)]ᵢ∈ [symbol] denotes the ith component of ϕ(x); and
(b) Evaluating Proj at x=(x₁, x₂, . . . , xₙ), xᵢ∈S, as

Proj(x)=Proj((x₁,x₂, . . . ,xₙ))=[ϕ(x)]₁⊙[ϕ(x)]₂⊙ . . . ⊙[ϕ(x)]ₙ.

The choosing of a set S can be formed in multiple ways. In a first method, the choosing of a set S such that each xᵢ∈S, a group [symbol] with group operation ⊙, and a function ϕ:

$$φ \text{:} \underbrace{S \times S \times … \times S}_{n copies} -> \underbrace{𝔾 \times 𝔾 \times … \times 𝔾}_{n copies} ,$$

which can be evaluated on the data x=(x₁, x₂, . . . , xₙ), xᵢ∈S, as

ϕ(x)=ϕ((x₁,x₂, . . . ,xₙ))=([ϕ(x)]₁,[ϕ(x)]₂, . . . ,[ϕ(x)]ₙ),

where [ϕ(x)]₁∈G denotes the ith component of ϕ(x), can involve:
(a) Choosing S={0,1}.
(b) Choosing a prime number p such that p≥2n, and defining [symbol] ₚ as the finite field of size p.
(c) Defining m=2e, q=p^{m}, and [symbol] _{q} as the finite field of size q.
(d) Choosing a quadratic non-residue c∈ [symbol] _{q}.
(e) Choosing a monic irreducible polynomial f(σ)=σ²−c in the polynomial ring [symbol] _{q}[σ].
(f) Defining the finite field [symbol] _{q}_{²}= [symbol] _{q}[σ]/ [symbol] f(σ) [symbol] with q² elements.
(g) Choosing [symbol] as the order-(q+1) cyclotomic subgroup of the multiplicative group [symbol] _{q}_{²}* of [symbol] _{q}_{²} with identity element 1.
(h) Choosing a representation for [symbol] such that

$$𝔾 = \{ \frac{α + σ}{α - σ} \text{:} α ∈ {𝔽}_{q} \} ⋃ \{ 1 \} .$$

(i) Choosing a subset of [symbol] [symbol] of [symbol] such that

$$ℱℬ = \{ \frac{α + σ}{α - σ} \text{:} α ∈ {𝔽}_{p} \} .$$

(j) Choosing an n-element subset [symbol] [symbol] S={G₁, G₂, . . . , Gₙ} of [symbol] [symbol] .
(k) Defining [ϕ(z)]ᵢ=Gᵢ^{-2x}^{ᵢ}⁺¹.

In a second method, the choosing of a set S such that each xᵢ∈S, a group [symbol] with group operation ⊙, and a function ϕ:

$$φ \text{:} \underbrace{S \times S \times … \times S}_{n copies} -> \underbrace{𝔾 \times 𝔾 \times … \times 𝔾}_{n copies} ,$$

which can be evaluated on the data x=(x₁, x₂, . . . , xₙ), xᵢ∈S, as

ϕ(x)=ϕ((x₁,x₂, . . . ,xₙ))=([ϕ(x)]₁,[ϕ(x)]₂, . . . ,[ϕ(x)]ₙ),

where [ϕ(X)]ᵢ∈ [symbol] denotes the ith component of ϕ(x), can involve:
(a) Choosing S⊂ [symbol] as a subset of the set of integers [symbol] .
(b) Choosing a prime number p such that p≥n, and defining [symbol] ₚ as the finite field of size p.
(c) Defining m=e, q=p^{m}, and [symbol] _{q} as the finite field of size q.
(d) Choosing a quadratic non-residue c∈ [symbol] _{q}.
(e) Choosing a monic irreducible polynomial f(σ)=σ²−c in the polynomial ring [symbol] _{q}[σ].
(f) Defining the finite field [symbol] _{q}²= [symbol] _{q}(σ)/ [symbol] f(σ) [symbol] with q² elements.
(g) Choosing [symbol] as the order-(q+1) cyclotomic subgroup of the multiplicative group [symbol] _{q}_{²}* of [symbol] _{q}_{²} with identity element 1.
(h) Choosing a representation for G such that

$$𝔾 = \{ \frac{α + σ}{α - σ} \text{:} α ∈ {𝔽}_{q} \} ⋃ \{ 1 \} .$$

(i) Choosing a subset [symbol] [symbol] of [symbol] such that

$$ℱℬ = \{ \frac{α + σ}{α - σ} \text{:} α ∈ {𝔽}_{p} \} .$$

(j) Choosing an n-element subset [symbol] [symbol] S={G₁, G₂, . . . , Gₙ} of [symbol] [symbol]
(k) Defining [ϕ(x)]ᵢ=Gᵢ^{x}^{ᵢ}.

The deriving a secure and noise-tolerant template tₓ from x and Proj(x) can then involve the steps of:
(a) Choosing a set S (according to either of the proceeding methods), a set [symbol] , and a function Proj such that

$$Proj \text{:} \underbrace{S \times S \times … \times S}_{n copies} -> 𝔾 ,$$

and which can be evaluated at x=(x₁, x₂, . . . , xₙ) so as to provide:

$$Proj ( x ) = \{ \frac{α + σ}{α - α} \} ∈ 𝔾$$

for some α∈ [symbol] _{q}.
(b) The secure template tₓ is then defined to be tₓ=α, where

$$Proj ( x ) = \frac{α + σ}{α - σ}$$

is computed as in the previous step.

Secure and Noise-Tolerant Data Comparison

Based on the foregoing, a general methodology can also provided for determining a similarity measure between a pair of data x∈X and y∈Y where the input to this method is a pair (tₓ,t_{y}), where tₓ∈T_{X} and t_{y}∈T_{Y} are secure and noise-tolerant templates of x and y. In one exemplary implementation, such a methodology can include the steps of:
(a) Choosing an error tolerance bound e and choosing the sets X, Y, Tₓ, T_{y}.
(b) Choosing a similarity/distance function d: X×Y→ [symbol] , where [symbol] is the set of real numbers.
(c) Defining a procedure Decomp: T_{X}×T_{Y}→ [symbol] such that the value Decomp(tₓ,t_{y}) can in particular determine whether d(x,y)≤e.
   The choosing of e and choosing the sets X, Y, Tₓ, T_{y} can involve
(a) Choosing e, wherein 0≤e≤n.
(b) Choosing

$$X = \underbrace{{S}_{1} \times {S}_{1} \times … \times {S}_{1}}_{n copies} and Y = \underbrace{{S}_{2} \times {S}_{2} \times … \times {S}_{2}}_{m copies} ,$$

as discussed above with respect to template generation, and choosing Tₓ to be the set of all possible secure templates tₓ of all data x in X and T_{y} to be the set of all possible secure templates t_{y} of all data y in Y, where tₓ and t_{y} are derived as discussed above with respect to template generation.

In some implementations, the choosing X, Y, Tₓ, T_{y} can be based on the first method for choosing S discussed above with respect to template generation. In particular, choosing:

$${S}_{1} = {S}_{2} = S = \{ 0 , 1 \} , X = Y = \underbrace{S \times S \times … \times S}_{n copies} .$$

In other implementations, the choosing X, Y, Tₓ, T_{y} can be based on the second method for choosing S discussed above with respect to template generation. In particular, choosing:

$${S}_{1} = {S}_{2} = S ⊆ ℤ , X = Y = \underbrace{S \times S \times … \times S}_{n copies} .$$

A first method for defining a procedure Decomp: T_{X}×T_{Y}→ [symbol] such that the value Decomp(tₓ,t_{y}) can in particular determine whether d(x,y)≤e, can therefore involve:
(a) Choosing X, Y, Tₓ, T_{y}, as previously discussed, where tₓ∈T_{X} and t_{y}∈T_{Y} are computed according to the first method for choosing S. In particular:

$${S}_{1} = {S}_{2} = S = \{ 0 , 1 \} , X = Y = \underbrace{S \times S \times … \times S}_{n copies} , .$$

(b) Choosing d: X×Y→ [symbol] as d(x, y)=Σᵢ₌₁ⁿ|xᵢ−yᵢ|, and
(c) Determining the value Decomp(tₓ,t_{y}), which can include the steps of
   i. If tₓ=t_{y}, then Decomp(tₓ,t_{y})=0;
   ii. If tₓ≠t_{y}, then compute

$$\frac{{t}_{z} + σ}{{t}_{z} - σ} = ( \frac{{t}_{x} + σ}{{t}_{x} - σ} ) {( \frac{{t}_{y} + σ}{{t}_{y} - σ} )}^{- 1} ,$$

iii. For k=1, 2, . . . , e, perform the 2 k-decomposition algorithm.
   A. If

$$\frac{{t}_{z} + σ}{{t}_{z} - σ}$$

is found to be decomposed for some k=1, 2, . . . , e such that

$$\frac{{t}_{z} + σ}{{t}_{z} - σ} = {\prod }_{j = 1}^{k} {( \frac{{α}_{j} + σ}{{α}_{j} - σ} )}^{2} ,$$

and that αⱼ∈{Gᵢ}ᵢ₌₁ⁿ∪{Gᵢ⁻¹}ᵢ₌₁ⁿ, then return the smallest such k as the return value of Decomp(tₓ,t_{y}). Otherwise, return −1 as the return value of Decomp(tₓ,t_{y}).
The negative return value for Decomp(tₓ,t_{y})=−1 indicates that d(x,y)>e.
The positive return value Decomp(tₓ,t_{y})=k indicates that d(x,y)=k≤e.

A second method for defining a procedure Decomp: T_{X}×T_{Y}→ [symbol] that the value Decomp(tₓ,t_{y}) can in particular determine whether d(x,y)≤e, can therefore involve:
(a) Choosing X, Y, Tₓ, T_{y} as previously discussed, where tₓ∈T_{X} and t_{y}∈T_{Y} are computed according to the second method for choosing S. In particular:

$${S}_{1} = {S}_{2} = S ⊆ ℤ , X = Y = \underbrace{S \times S \times … \times S}_{n copies} , .$$

(b) Choosing d: X×Y→ [symbol] as d(x, y)=Σᵢ₌₁ⁿ|xᵢ−yᵢ|, and
(c) Determining the value Decomp(tₓ,t_{y}), which can include the steps of
   i. If tₓ=t_{y}, then Decomp(tₓ,t_{y})=0;
   ii. If tₓ≠t_{y}, then compute

$$\frac{{t}_{z} + σ}{{t}_{z} - σ} = ( \frac{{t}_{x} + σ}{{t}_{x} - σ} ) {( \frac{{t}_{y} + σ}{{t}_{y} - σ} )}^{- 1} ,$$

iii. For k=1, 2, . . . , e, perform the 2 k-decomposition algorithm.
   A. If

$$\frac{{t}_{z} + σ}{{t}_{z} - σ}$$

is found to be decomposed for some k=1, 2, . . . , e such that

$$\frac{{t}_{z} + σ}{{t}_{z} - σ} = {\prod }_{j = 1}^{k} ( \frac{{α}_{j} + σ}{{α}_{j} - σ} )$$

and that αⱼ∈{Gᵢ}ᵢ₌₁ⁿ∪{Gᵢ⁻¹}ᵢ₌₁ⁿ, then return the smallest such k as the return value of Decomp(tₓ,t_{y}). Otherwise, return −1 as the return value of Decomp(tₓ,t_{y}).
The negative return value for Decomp(tₓ,t_{y})=−1 indicates that d(x,y)>e.
The positive return value Decomp(tₓ,t_{y})=k indicates that d(x,y)=k≤e.

Randomized Template Generation

As noted above, in some implementations, a randomized secure template of a data can be generated. Thus a general methodology of generating a secure and noise-tolerant and randomized template tₓ of data x can be provided, where x=(x₁, x₂, . . . , xₙ) has n digits and each xᵢ belongs to a set S. In one exemplary implementation, such a methodology can include the steps of:
(a) Choosing a number e, where 0≤e≤n, as the noise tolerance bound.
(b) Choosing a set S, a set [symbol] , a set R, and a function Proj

$$Proj \text{:} \underbrace{S \times S \times … \times S}_{n copies} \times R \to 𝔾 ,$$

which can be evaluated at (x, r)=((x₁, x₂, . . . , xₙ), r∈R.
(c) Deriving a secure and noise-tolerant and randomized template rtₓ from x, r, and Proj(x,r).

The choosing a set S, a set R, a set [symbol] , and a function Proj such that

$$Proj \text{:} \underbrace{S \times S \times … \times S}_{n copies} \times R \to 𝔾 ,$$

which can be evaluated on the data (x, r)=((x₁, x₂, . . . , xₙ), r), r∈R can involve:
(a) Choosing a set S such that each xᵢ∈S, a set R, a group [symbol] with group operation ⊙, and a function ϕ

$$φ \text{:} \underbrace{S \times S \times … \times S}_{n copies} \times R \to \underbrace{𝔾 \times 𝔾 \times … \times 𝔾}_{n copies} ,$$

which can be evaluated on the data

(x,r)=((x₁,x₂, . . . ,xₙ),r),xᵢ∈S,r∈R′ as

ϕ(x,r)=ϕ((x₁,x₂, . . . ,xₙ),r=([ϕ(x,r)]₁,[ϕ(x,r)]₂, . . . ,[ϕ(x,r)]ₙ),
where [ϕ(x,r)]ᵢ∈ [symbol] denotes the ith component of ϕ(x,r).
(b) Evaluating Proj at x=(x₁, x₂ . . . , xₙ), xᵢ∈S, as

Proj(x,r)=Proj((x₁,x₂, . . . ,xₙ),r)=[ϕ(x,r)]₁⊙[ϕ(x,r)]₂⊙ . . . ⊙[ϕ(x,r)]ₙ.

The choosing of a set S can be formed in multiple ways. In a first method, the choosing a set S such that each xᵢ∈S, a set R, a group [symbol] with group operation ⊙, and a function ϕ:

$$φ \text{:} \underbrace{S \times S \times … \times S}_{n copies} \times R \to \underbrace{𝔾 \times 𝔾 \times … \times 𝔾}_{n copies} ,$$

which can be evaluated on the data (x, r)=((x₁, x₂, . . . xₙ),r), xᵢ∈S, r∈R, as ϕ(x, r)=ϕ((x₁, x₂, . . . , xₙ), r)=([ϕ(x, r)]₁, [ϕ(x, r)]₂, . . . , [ϕ(x,r)]n), where [ϕ(x, r)]ᵢ∈ [symbol] denotes the ith component of ϕ(x,r), can involve the steps of
(a) Choosing S={0,1}.
(b) Choosing

$$R = \underbrace{\{ - 1 , 1 \} \times \{ - 1 , 1 \} \times … \times \{ - 1 , 1 \}}_{n copies}$$

(c) Choosing a prime number p such that p≥2n, and defining [symbol] ₚ as the finite field of size p.
(d) Defining m=2e, q=p^{m}, and [symbol] _{q} as the finite field of size q.
(e) Choosing a quadratic non-residue c∈ [symbol] _{q}.
(f) Choosing a monic irreducible polynomial f(σ)=σ²−c in the polynomial ring [symbol] _{q}[σ]
(g) Defining the finite field [symbol] _{q}_{²}= [symbol] _{q}[σ]/ [symbol] f(σ) [symbol] with q² elements.
(h) Choosing [symbol] as the order-(q+1) cyclotomic subgroup of the multiplicative group [symbol] _{q}_{²} of [symbol] _{q}_{²} with identity element 1.
(i) Choosing a representation for [symbol] such that

$$𝔾 = \{ \frac{α + σ}{α - σ} \text{:} α ∈ {𝔽}_{q} \} ⋃ \{ 1 \} .$$

(j) Choosing a subset [symbol] [symbol] of [symbol] such that

$$ℱℬ = \{ \frac{α + σ}{α - σ} \text{:} α ∈ {𝔽}_{p} \} .$$

(k) Choosing an n-element subset [symbol] [symbol] [symbol] ={G₁, G₂, . . . , Gₙ} of [symbol] [symbol]
(l) Defining [ϕ(x,r)]ᵢ=Gᵢ^{(-2x}^{ᵢ}^{+1)r}^{ᵢ}, where r=(r₁, r₂, . . . , rₙ)∈R.

In a second method, the choosing a set S such that each xᵢ∈S, a set R, a group [symbol] with group operation ⊙, and a function ϕ:

$$φ \text{:} \underbrace{S \times S \times … \times S}_{n copies} \times R \to \underbrace{𝔾 \times 𝔾 \times … \times 𝔾}_{n copies} ,$$

which can be evaluated on the data (x,r)=(x₁, x₂, . . . , xₙ),r), xᵢ∈S, r∈R, as ϕ(x,r)=ϕ((x₁, x₂, . . . , xₙ),r)=([ϕ(x,r)]₁, [ϕ(x,r)]₂, . . . , [ϕ(x,r)]ₙ), where [ϕ(x, r)]ᵢ∈ [symbol] denotes the ith component of ϕ(x, r), can involve the steps of
(a) Choosing S⊂ [symbol] as a subset of the set of integers [symbol] .
(b) Choosing

$$R = \underbrace{\{ - 1 , 1 \} \times \{ - 1 , 1 \} \times … \times \{ - 1 , 1 \}}_{n copies}$$

(c) Choosing a prime number p such that p≥2n, and defining [symbol] ₚ as the finite field of size p.
(d) Defining m=e, q=p^{m}, and [symbol] _{q} as the finite field of size q.
(e) Choosing a quadratic non-residue c∈ [symbol] _{q}.
(f) Choosing a monic irreducible polynomial f(σ)=σ²−c in the polynomial ring [symbol] _{q}[σ].
(g) Defining the finite field [symbol] _{q}_{²}= [symbol] _{q}[σ]/ [symbol] f(σ) [symbol] with q² elements.
(h) Choosing [symbol] as the order-(q+1) cyclotomic subgroup of the multiplicative group of [symbol] _{q}_{²} of [symbol] _{q}_{²} with identity element 1.
(i) Choosing a representation for [symbol] such that

$$𝔾 = \{ \frac{α + σ}{α - σ} \text{:} α ∈ {𝔽}_{q} \} ⋃ \{ 1 \} .$$

(j) Choosing a subset [symbol] [symbol] of [symbol] such

$$ℱℬ = \{ \frac{α + σ}{α - σ} : α ∈ {𝔽}_{p} \} .$$

(k) Choosing an n-element subset [symbol] [symbol] [symbol] ={G₁, G₂, . . . , Gₙ} of [symbol] [symbol] .
(l) Defining [ϕ(x,r)]ᵢ=Gᵢ^{x}^{ᵢ}^{r}^{ᵢ}
   , where r=(r₁, r₂, . . . , rₙ)∈R.

The deriving a secure and noise-tolerant template tₓ from x and Proj(x) can then involve the steps of:
(a) Choosing a set S (according to either of the proceeding methods), a set R, a set [symbol] , and a function Proj such that

$$Proj : \underbrace{S \times S \times … \times S}_{n copies} \times R \to 𝔾 ,$$

and which can be evaluated at (x,r)=((x₁, x₂, . . . , xₙ),r, so as to provide:

$$Proj ( x , r ) = \frac{α + σ}{α - σ} ∈ 𝔾$$

for some α∈ [symbol] _{q}.
(b) The secure template rtₓ is then defined to be (tₓ, r), where tₓ=α, where

$$Proj ( x , r ) = \frac{α + σ}{α - σ} ∈ 𝔾$$

is computed as in the previous step.

Randomized Data Comparison

Based on the foregoing, a general methodology can also provided for determining a similarity measure between a pair of data x∈X and y∈Y where the input to this method is a pair (rtₓ,rt_{y}), where rtₓ∈T_{X} and rt_{y}∈T_{Y} are secure and noise-tolerant templates of x and y. In one exemplary implementation, such a methodology can include the steps of:
(a) Choosing an error tolerance bound e and choosing the sets X, Y, Tₓ, T_{y}.
(b) Choosing a similarity/distance function d: X×Y→ [symbol] , where [symbol] is the set of real numbers.
(c) Defining a procedure Decomp: T_{X}×T_{Y}→ [symbol] such that the value
Decomp(rtₓ,rt_{y}), can in particular determine whether d(x,y)≤e.
   The choosing of e and choosing the sets X, Y, Tₓ, T_{y} can involve
(a) Choosing e, wherein 0≤e≤n.
(b) Choosing

$$X = \underbrace{{S}_{1} \times {S}_{1} \times … \times {S}_{1}}_{n copies} and Y = \underbrace{{S}_{2} \times {S}_{2} \times … \times {S}_{2}}_{m copies} ,$$

as discussed above with respect to template generation, and choosing Tₓ to be the set of all possible secure and randomized templates rtₓ of all data x in X and T_{y} to be the set of all possible secure and randomized templates rt_{y} of all data y in Y, where rtₓ and rt_{y} are derived as discussed above with respect to randomized template generation.

In some implementations, the choosing X, Y, Tₓ, T_{y}, can be based on the first method for choosing S discussed above with respect to template generation. In particular, choosing:

$${S}_{1} = {S}_{2} = S = \{ 0 , 1 \} , X = Y = \underbrace{S \times S \times … \times S}_{n copies} .$$

In other implementations, the choosing X, Y, Tₓ, T_{y}, can be based on the second method for choosing S discussed above with respect to template generation. In particular, choosing:

$${S}_{1} = {S}_{2} = S ⊆ ℤ , X = Y = \underbrace{S \times S \times … \times S}_{n copies} .$$

A first method for defining a procedure Decomp: T_{X}×T_{Y}→ [symbol] such that the value Decomp(rtₓ,rt_{y}) can in particular determine whether d(x,y)≤e, can therefore involve:
(a) Choosing X, Y, Tₓ, T_{y} as previously discussed, where rtₓ∈T_{X} and rt_{y}∈T_{Y} are computed according to the first method for choosing S. In particular:

$${S}_{1} = {S}_{2} = S \{ 0 , 1 \} , X = Y = \underbrace{S \times S \times … \times S}_{n copies} , .$$

(b) Choosing d: X×Y→ [symbol] as d(x, y)=Σᵢ₌₁ⁿ|xᵢ−yᵢ|, and
(c) Determining the value Decomp(rtₓ,rt_{y}), which can include the steps of
   i. If tₓ=t_{y}, then Decomp(rtₓ,rt_{y})=0;
   ii. If tₓ≠t_{y}, then compute

$$\frac{{t}_{z} + σ}{{t}_{z} - σ} = ( \frac{{t}_{x} + σ}{{t}_{x} - σ} ) {( \frac{{t}_{y} + σ}{{t}_{y} - σ} )}^{- 1} ,$$

iii. For k=1, 2, . . . , e, perform the 2 k-decomposition algorithm.
   A. If

$$\frac{{t}_{z} + σ}{{t}_{z} - σ}$$

is found to be decomposed for some k=1, 2, . . . , e such that

$$\frac{{t}_{z} + σ}{{t}_{z} - σ} = {\prod }_{j = 1}^{k} {( \frac{{α}_{j} + σ}{{α}_{j} - σ} )}^{2} ,$$

and that αⱼ∈{Gᵢ}ᵢ₌₁ⁿ∪{Gᵢ⁻¹}ᵢ₌₁ⁿ, then return the smallest such k as the return value of Decomp(rtₓ,rt_{y}). Otherwise, return −1 as the return value of Decomp(rtₓ,rt_{y}).
The negative return value for Decomp(rtₓ,rt_{y})=−1 indicates that d(x,y)>e.
The positive return value Decomp(rtₓ,rt_{y})=k indicates that d(x,y)=k<e.

A second method for defining a procedure Decomp: T_{X}×T_{Y}→ [symbol] such that the value Decomp(tₓ,t_{y}) can in particular determine whether d(x,y)≤e, can therefore involve:
(a) Choosing X, Y, Tₓ, T_{y} as previously discussed, where rtₓ∈T_{X} and rt_{y}∈T_{Y} are computed according to the second method for choosing S. In particular:

$${S}_{1} = {S}_{2} = S ⊆ ℤ , X = Y = \underbrace{S \times S \times … \times S}_{n copies} , .$$

(b) Choosing d: X×Y→ [symbol] as d(x, y)=Σᵢ₌₁ⁿ|xᵢ−yᵢ|, and
(c) Determining the value Decomp(rtₓ,rt_{y}), which can include the steps of
   i. If tₓ=t_{y}, then Decomp(rtₓ,rt_{y})=0;
   ii. If tₓ≠t_{y}, then compute

$$\frac{{t}_{z} + σ}{{t}_{z} - σ} = ( \frac{{t}_{x} + σ}{{t}_{x} - σ} ) {( \frac{{t}_{y} + σ}{{t}_{y} - σ} )}^{- 1} ,$$

iii. For k=1, 2, . . . , e, perform the 2 k-decomposition algorithm.
   A. If

$$\frac{{t}_{z} + σ}{{t}_{z} - σ}$$

is found to be decomposed for some k=1, 2, . . . , e such that

$$\frac{{t}_{z} + σ}{{t}_{z} - σ} = {\prod }_{j = 1}^{k} ( \frac{{α}_{j} + σ}{{α}_{j} - σ} )$$

and that αⱼ∈{Gᵢ}ᵢ₌₁ⁿ∪{Gᵢ⁻¹}ᵢ₌₁ⁿ, then return the smallest such k as the return value of Decomp(rtₓ,rt_{y}). Otherwise, return −1 as the return value of Decomp(rtₓ,rt_{y}).
The negative return value for Decomp(rtₓ,rt_{y})=−1 indicates that d(x,y)>e.
The positive return value Decomp(rtₓ,rt_{y})=k indicates that d(x,y)=k≤e.

Fixed Length Representation of Fingerprints

As discussed above, one particular implementation involves the use of biometric information, such as fingerprints. Further, as discussed above, prior to generating the secure template a class 2 component may be used to generate a representation of the acquired data. For example, an input to a class 2 component may be a fingerprint image and the output of the class 2 component may be a representation of the fingerprint suitable to be used in the secure template generation. In particular, a suitable representation may be a collection of fixed length vectors.

In one exemplary method, this can involve the steps of:
(a) Determining the minutiae point set of the given fingerprint as

M={M(i):M(i)=(x(i),y(i),θ(i)), i=1,2, . . . ,k},
where x(i),y(i),θ(i) represent the x-coordinate, y-coordinate, and the angle of the ith minutiae point M(i).
(b) Choosing a number n as to represent the number of neighbours.
(c) Determining a fixed length local sequence L(i).
(d) Determining a sequence X(i) by scaling each local sequence L(i) using a scaling factor s.
(e) Representing the given fingerprint by the collection of fixed length vectors X={(X(i)}ᵢ₌₁^{k}.
(f) Storing X as the vector representation of the fingerprint.

In some implementations, the step of determining the fixed length local sequence L(i) can include the steps of:
(a) Determining an n-element neighbour-set:

N(i)={Nⱼ(i):Nⱼ(i)=(xⱼ(i),yⱼ(i),θⱼ(i))∈M, j=1,2, . . . ,n}
of the i'th minutiae M(i). This step can include sub-steps of
   i. Choosing Nⱼ(i) (for j=1, . . . , n) from the minutiae set M\M(i) such that the distances dⱼ(i) between M(i) and Nⱼ(i) are minimum among all possible distances between all distinct pairs of minutiae points.
   ii. Determining αⱼ(i) (for j=1, . . . , n) to be the angle between the two lines l₁ and l₂, where l₁ is the line that passes through (x(i),y(i)) and xⱼ(i),yⱼ(i)); and l₂ is the line that passes through (x(i),y(i)) in the direction of θ(i).
   iii. Determining βⱼ(i) as the relative angle between θ(i) and θⱼ(i) for j=1, . . . , n.
(b) Defining L(i)=[d₁(i), . . . , dₙ(i), α₁(i), . . . , αₙ(i), β₁(i), . . . , βₙ(i)], where dⱼ(i), αⱼ(i), βⱼ(i) are computed as in the previous step for i=1, . . . , k.

Determining a sequence X(i), by scaling each local sequence L(i) using a scaling factor s, can include choosing a scaling factor s=(s₁,s₂,s₃), where each sᵢ is a real number and defining

X(i)=[└d₁(i)/s₁┘, . . . ,└dₙ(i)/s₁┘,└α₁(i)/s₂┘, . . . ,└αₙ(i)/s₂┘,└β₁(i)/s₃┘, . . . ,└βₙ(i)/s₃┘]

for i=1, . . . , k.

Secure Data Enrollment

As noted above, components are combined together to perform a secure and noise-tolerant enrollment of a data. In a particular implementation, the enrollment can include:
(a) Defining a system consisting of distinct of several classes of components and/or computing units, as discussed above. Each class consists of several components and/or computing units of the same type. Six classes of components can be defined as
   Cl₁={C₁ᵢ:i=1, 2, 3, . . . }
   Cl₂={C₂ᵢ:i=1, 2, 3, . . . }
   Cl₃={C₃ᵢ:i=1, 2, 3, . . . }
   Cl₄={C₄ᵢ:i=1, 2, 3, . . . }
   Cl₅={C₅ᵢ:i=1, 2, 3, . . . }
   Cl₆={C₆ᵢ:i=1, 2, 3, . . . }
(b) Capturing and/or processing information b∈B through a component C₁ in class Cl₁. Given the input b∈B, C₁ verifies the authenticity of b and outputs an error message if b is not authentic. If b is authentic, C₁ outputs d∈D, and C₁ sends an authentic and encrypted copy of d to a second component C₂ in class Cl₂.
(c) Given the input d∈D, C₂ verifies the authenticity of d and outputs an error message if d is not authentic. If d is authentic, C₂ outputs a collection {X(j)}ⱼ₌₁^{k}∈X of fixed length vectors, and C₂ sends an authentic and encrypted copy of {X(j)}ⱼ₌₁^{k} to a third component C₃ in class Cl₃. {X(j)}ⱼ₌₁^{k} can be generated from d as discussed above for a fingerprint.
(d) Given the input {X(j)}_{j=1′}^{k}, C₃ verifies the authenticity of {X(j)}ⱼ₌₁^{k} and outputs an error message if {X(j)}ⱼ₌₁^{k} is not authentic. If {X(j)}ⱼ₌₁^{k} is authentic, C₃ outputs a collection of {^{t}X(j)}ⱼ₌₁^{k}∈T_{X} (or secure and noise-tolerant and randomized templates {^{rt}X(j)}ⱼ₌₁^{k}∈T_{X}), and C₃ sends an authentic and encrypted copy of {^{t}X(j)}ⱼ₌₁^{k}∈T_{X} (or {^{rt}X(j)}ⱼ₌₁^{k}∈T_{X}) to a fourth component C₄ in class Cl₄. {^{t}X(j)}ⱼ₌₁^{k}∈T_{X} (or {^{rt}X(j)}ⱼ₌₁^{k}∈T_{X}) can be generated using the template generation methods discussed above.
(e) Given the input {^{t}X(j)}ⱼ₌₁^{k} (or {^{rt}X(j)}ⱼ₌₁^{k}), C₄ verifies the authenticity of its input and outputs an error message if its input is not authentic. If the input is authentic, C₄ stores and encrypted and authentic copy of its input together with some identifier of its input, where the identifier may just be a blank string indicating that there is no identifier.

Secure Data Matching

As noted above, components are combined together to perform a secure and noise-tolerant matching of data. In a particular implementation, the matching process can include:
(a) Choosing a noise tolerance bound e.
(b) Defining a system consisting of distinct of several classes of components and/or computing units. Each class consists of several components and/or computing units of the same type. Six classes of components are defined as
   Cl₁={C₁ᵢ:i=1, 2, 3, . . . }
   Cl₂={C₂ᵢ:i=1, 2, 3, . . . }
   Cl₃={C₃ᵢ:i=1, 2, 3, . . . }
   Cl₄={C₄ᵢ:i=1, 2, 3, . . . }
   Cl₅={C₅ᵢ:i=1, 2, 3, . . . }
   Cl₆={C₆ᵢ:i=1, 2, 3, . . . }
(c) Capturing and/or processing information b∈B through a component C₁ in class Cl₁. Given the input b∈B, C₁ verifies the authenticity of b and outputs an error message if b is not authentic. If b is authentic, C₁ outputs d∈D, and C₁ sends an authentic and encrypted copy of d to a second component C₂ in class Cl₂.
(d) Given the input d∈D, C₂ verifies the authenticity of d and outputs an error message if d is not authentic. If d is authentic, C₂ outputs a collection {X(j)}ⱼ₌₁^{k}∈X of fixed length vectors, and C₂ sends an authentic and encrypted copy of {X(j)}ⱼ₌₁^{k} to a third component C₃ in class Cl₃. As discussed above, C₂ can generate {X(j)}ⱼ₌₁^{k} from d as discussed above with respect to fingerprints.
(e) Given the input {X(j)}ⱼ₌₁^{k}, C₃ verifies the authenticity of {X(j)}ⱼ₌₁^{k} and outputs an error message if {X(j)}ⱼ₌₁^{k} is not authentic. If {X(j)}ⱼ₌₁^{k} is authentic, C₃ outputs a collection of {^{t}X(j)}ⱼ₌₁^{k} ∈T_{X} (or secure and noise-tolerant and randomized templates {^{rt}X(j)}ⱼ₌₁^{k}∈T_{X}), and C₃ sends an authentic and encrypted copy of {^{t}X(j)}ⱼ₌₁^{k}∈T_{X} (or {^{rt}X(j)}ⱼ₌₁^{k}∈T_{X}) to a fifth component C₅ in class Cl₅. As discussed above, {^{t}X(j)}ⱼ₌₁^{k}∈T_{X} (or {^{rt}X(j)}ⱼ₌₁^{k}∈T_{X}) can be generated using any of the template generating methods discussed herein.
(f) Given the input {^{t}X(j)}ⱼ₌₁^{k}∈T_{X} (or {^{rt}X(j)}ⱼ₌₁^{k}, C₅ verifies the authenticity of its input and outputs an error message if its input is not authentic. If the input is authentic, C₅ queries a component C₄. C₅'s query is encrypted and authentic, and may include certain identifiers.
(g) C₅ verifies the authenticity of the received query and outputs an error message if the query is not authentic. C₄ responds to authentic queries by sending a (sub)collection of its content consisting of {^{t}Y(j)}ⱼ₌₁^{k} (or {^{rt}Y(j)}ⱼ₌₁^{k}). This (sub)collection may be the whole set of C₄'s content, or C₄ may reveal only a particular subset of its content determined by the identifiers. C₄ sends an authentic and encrypted copy of this (sub)collection to C₅.
(h) C₅ verifies the authenticity of the collection of {^{t}Y(j)}ⱼ₌₁^{l} (or {^{rt}Y(j)}ⱼ₌₁^{l}) and outputs an error message if it is not authentic. If the content is authentic, then C₅ computes a score-set by comparing {^{t}X(j)}ⱼ₌₁^{k} (or {^{rt}X(j)}ⱼ₌₁^{k}) to each {^{t}Y(j)}ⱼ₌₁^{l} (or {^{rt}Y(j)}ⱼ₌₁^{l}) in the received collection. C₅ sends an authentic and encrypted copy of this score-set to C₆.
(i) C₆ verifies the authenticity of the received score-set and outputs an error message if it is not authentic. If the score is authentic, then C₆ compares this score-set to a threshold number t and outputs 0 or 1. Here, the output 1 indicates that b is similar (with respect to the noise-tolerance e and the threshold) to at least one of the data which was stored and revealed by C₄ in the process. The output 0 indicates that b is not similar to any of the data which was stored and revealed by C₄ in the process. For example, C₆ can output 1 if at least one of the scores in the score-set is greater than or equal to a threshold t and can output 0 if all the scores in the score-set are less than t.
   As discussed above, C₅ can compute a score-set by comparing {^{t}X(j)}ⱼ₌₁^{k} (or {^{rt}X(j)}ⱼ₌₁^{k}) to each {^{t}Y(j)}ⱼ₌₁^{l} (or {^{rt}Y(j)}ⱼ₌₁^{l}) in the received collection by, in the absence of randomization by defining s(X,Y) as the score of the pair {^{t}X(j)}ⱼ₌₁^{k}, {^{t}Y(j)}ⱼ₌₁^{l}, where s(X,Y)=|{(i,j): Decomp(t_{X(i)},t_{Y(j)}≤c, i=1, . . . , k, j=1, . . . , l}|, and computing Decomp as discussed above. In the case of randomization, this is performed by defining s(X,Y) as the score of the pair {^{rt}X(j)}ⱼ₌₁^{k}, {^{rt}Y(j)}ⱼ₌₁^{l}, where s(X, Y)=|{(i,j): Decomp(rt_{X(i)},rt_{Y(j)})≤e i=1, . . . , k, j=1, . . . , l}|, and computing Decomp as discussed above. In the end, the score-set consists of all s(X,Y).

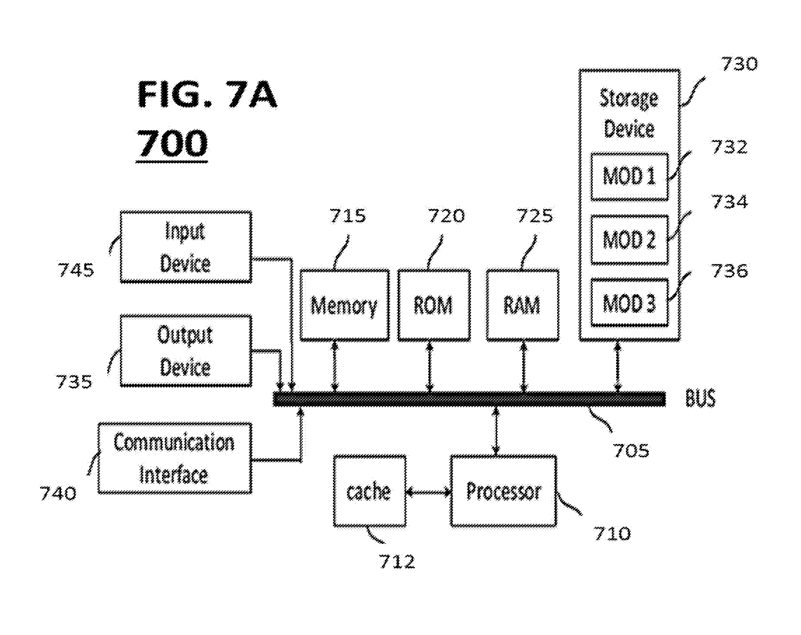

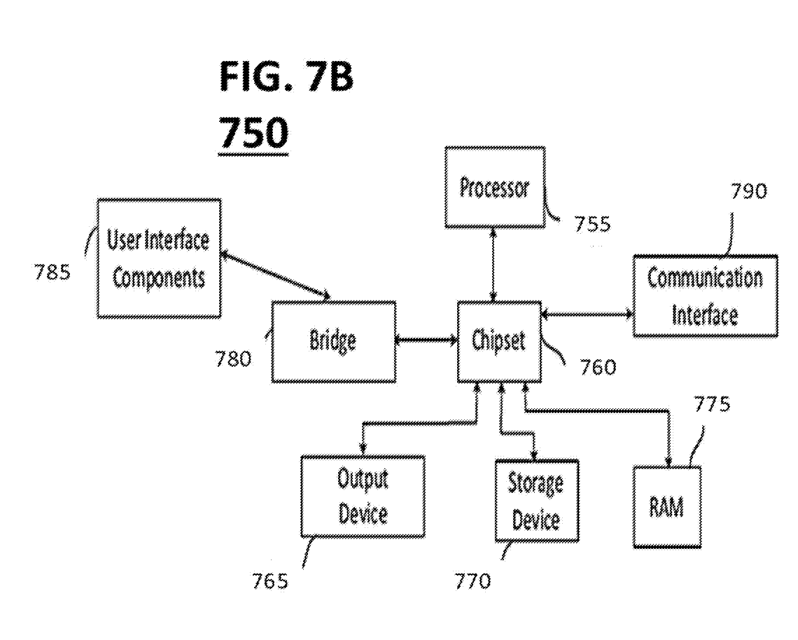

FIG. 7A and FIG. 7B illustrate exemplary possible system embodiments. The more appropriate embodiment will be apparent to those of ordinary skill in the art when practicing the various aspects of the present disclosure. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

While some aspects of the present disclosure have been described above, it should be understood that they have been presented by way of example only, and not limitation. Numerous changes to the disclosed embodiments can be made in accordance with the disclosure herein without departing from the spirit or scope of the various aspects of the present disclosure. Thus, the breadth and scope of the various aspects of the present disclosure should not be limited by any of the above described embodiments. Rather, the scope of various aspects of the present disclosure should be defined in accordance with the following claims and their equivalents.

Although the various aspects of the present disclosure have been illustrated and described with respect to one or more implementations, equivalent alterations and modifications will occur to others skilled in the art upon the reading and understanding of this specification and the annexed drawings. In addition, while a particular aspect of the present disclosure may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the various aspects of the present disclosure. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. Also, the terms “about”, “substantially”, and “approximately”, as used herein with respect to a stated value or a property, are intend to indicate being within 20% of the stated value or property, unless otherwise specified above. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method, comprising:
obtaining an input data set representing a raw data set associated with a user;
generating a secure and noise tolerant template for the input data set, the template configured to reveal limited features of the input data set and prevent reconstruction of the input data set from the template;
storing the template in an enrollment database.

2. The method of claim 1, wherein obtaining the input data set comprises receiving the raw data associated with the user via a biometric scanning device and converting the raw data into the input data set.

3. The method of claim 1, wherein obtaining the input data set comprises receiving the raw data associated with the user via at least one of an audio input device, an image input device, a video input device, or a computer interface input device.

4. The method of claim 1, wherein the obtaining further comprises representing the raw data set using one or more vectors to yield the input data set, and wherein the generating comprises:
mapping the one or more vectors in the input data set to one or more new vectors with elements in a pre-defined algebraic set;
applying a pre-defined algebraic operator to the one or more new vectors to yield a projection of the input data set; and
deriving the template from the projection based on a noise tolerance bound.

5. The method of claim 4, wherein the mapping further comprises applying a randomization set to randomize at least a portion of one or more new vectors.

6. A method, comprising:
obtaining a pair of templates corresponding to first and second input data sets to be compared, each of the pair of templates comprising a secure and noise tolerant template configured to reveal limited features of the corresponding input data set and to prevent reconstruction of the corresponding input data set from the secure and noise tolerant template;
comparing the pair of templates using a pre-defined comparison function to yield a similarity measure;
if the similarity measure meets a similarity criteria, determining that the first and the second input data are from a same source.

7. The method of claim 6, wherein the obtaining comprises:
receiving the first input data set;
generating a first one of the pair of templates corresponding to the first input data; and
retrieving a second one of the pair of templates from a database.

8. The method of claim 7, further comprising receiving a user identifier associated with the first input data set, and wherein the retrieving comprises identifying the second one of the pair of templates in the database based on the user identifier.

9. The method of claim 6, wherein the comparing comprises:
evaluating the pair of templates using the pre-defined comparison function to yield a comparison result;
if the comparison result is that the pair of templates are identical, configuring the similarity measure to indicate the first and the second input data are from a same source;
if the comparison result is that the pair of templates are different, performing a decomposition procedure using the pair of templates and configuring the similarity measure according to the result of the decomposition procedure.

10. The method of claim 9, wherein performing the decomposition procedure comprises:
deriving, using a mathematical function of the pair of templates, an element from an algebraic set;
decomposing the element as a product of elements of the algebraic set with a set of corresponding factors;
if the set of corresponding factors belongs to a pre-defined subset of the algebraic set, configuring the similarity measure to indicate the first and the second input data lie within the noise tolerance bound; and
if the set of corresponding factors are outside the pre-defined subset of the algebraic set, configuring the similarity measure to indicate the first and the second input data lie outside the noise tolerance bound.

11. The method of claim 6, wherein the comparing comprises:
evaluating the pair of templates using the pre-defined comparison function to yield a comparison result;
if the comparison result is that at least a portion of the pair of templates are identical, configuring the similarity measure to indicate the first and the second input data are from a same source;
if the comparison result is that the pair of templates are different, performing a decomposition procedure using the pair of templates and configuring the similarity measure according to the result of the decomposition procedure.

12. A computer-readable medium having stored thereon a plurality for instructions for causing a computing device to perform any of claims 1-11.

13. An apparatus, comprising:
at least one processing element; and
a computer-readable medium having stored thereon a plurality for instructions for causing the at least one processing element to perform any of claims 1-11.

14. An apparatus, comprising:
a set of data processing components; and
at least one database unit configured for storing data,
wherein the set of data processing components defines one or more enrollment units, each of the enrollment units configured to obtain an input data set representing a raw data set associated with a user, generate a secure and noise tolerant template for the input data set, and store the template in an enrollment database, wherein the template is configured to reveal limited features of the input data set and prevent reconstruction of the input data set from the template.

15. The apparatus of claim 14, wherein each of the enrollment units comprises a first component for obtaining the raw data set associated with the user, and a second component for converting the raw data into the input data set.

16. The apparatus of claim 15, wherein the first component comprises at least one of a biometric scanner device, an audio input device, an image input device, a video input device, or a computer interface input device.

17. The apparatus of claim 15, wherein the second component converts the raw data set into one or more vectors to yield the input data set, wherein each of the enrollment units comprises a third component for generating the template by:
mapping the one or more vectors in the input data set to one or more new vectors with elements in a pre-defined algebraic set;
applying a pre-defined algebraic operator to the one or more new vectors to yield a projection of the input data set; and
deriving the template from the projection based on a noise tolerance bound.

18. The apparatus of claim 17, wherein the third component is configured for performing the mapping by applying a randomization set to randomize at least a portion of one or more new vectors.

19. The apparatus of claim 14, wherein the set of data components communicate with each other using secure and authentic communications.

20. An apparatus, comprising:
a set of data processing components; and
wherein the set of data processing components defines one or more comparison units, each of the comparison units configured to obtain a pair of templates corresponding to first and second input data sets to be compared, comparing the pair of templates using a pre-defined comparison function to yield a similarity measure, determining that the first and the second input data are the same if the similarity measure meets a similarity criteria,
wherein each of the pair of templates comprises a secure and noise tolerant template configured to reveal limited features of the corresponding input data set and to prevent reconstruction of the corresponding input data set from the secure and noise tolerant template;

21. The apparatus of claim 20, further comprising a database, wherein each of the comparison units comprises:
a first component for receiving the first input data set,
a second component for generating a first one of the pair of templates corresponding to the first input data, and
a third component for receiving the first one of the pair of templates, retrieving a second one of the pair of templates from a database, and performing the determining.

22. The apparatus of claim 21, wherein the third component is further configured for receiving a user identifier associated with the first input data set and for identifying the second one of the pair of templates in the database based on the user identifier.

23. The apparatus of claim 20, further comprising a fourth component configured for performing the comparing by:
evaluating the pair of templates using the pre-defined comparison function to yield a comparison result;
if the comparison result is that the pair of templates are identical, configuring the similarity measure to indicate the first and the second input data are from a same source;
if the comparison result is that the pair of templates are different, performing a decomposition procedure using the pair of templates and configuring the similarity measure according to the result of the decomposition procedure.

24. The apparatus of claim 23, wherein performing the decomposition procedure comprises:
deriving, using a mathematical function of the pair of templates, an element from an algebraic set;
decomposing the element as a product of elements of the algebraic set with a set of corresponding factors;
if the set of corresponding factors belongs to a pre-defined subset of the algebraic set, configuring the similarity measure to indicate the first and the second input data lie within the noise tolerance bound; and
if the set of corresponding factors are outside the pre-defined subset of the algebraic set, configuring the similarity measure to indicate the first and the second input data lie outside the noise tolerance bound.

25. The apparatus of claim 20, further comprising a fourth component configured for performing the comparing by:
evaluating the pair of templates using the pre-defined comparison function to yield a comparison result;
if the comparison result is that the pair of templates are identical, configuring the similarity measure to indicate the first and the second input data are same source;
if the comparison result is that the pair of templates are different, performing a decomposition procedure using the pair of templates and configuring the similarity measure according to the result of the decomposition procedure.

26. The apparatus of claim 20, wherein the set of data components communicate with each other using secure and authentic communications.

27. A method, comprising:
obtaining location and orientation information for each a plurality of minutiae associated with a fingerprint;
identifying an n-element set corresponding to each one of the plurality of minutiae, each n-element set comprising n others of the plurality of minutiae neighboring the corresponding one of the plurality of minutiae;
determining a first set of vectors for each n-element neighboring set comprising distance and orientation information for each one of the n others of the plurality of minutiae with respect to the corresponding one of the plurality of minutiae;
transforming the first set of vectors into a second set of vectors, each vector of the second set of vectors having a fixed length; and
storing the second set of vectors as the vector representation of the fingerprint.

28. The method of claim 27, wherein the identifying further comprises selecting the n others of the plurality of minutiae to be pairwise distinct and to be the n closest to the corresponding one of the plurality of minutiae.

29. The method of claim 27, wherein each vector from the first set of vectors is associated with a one of the n others of the plurality of minutiae, and wherein each vector comprises a distance between the one of the n others of the plurality of minutiae and the corresponding one of the plurality of minutiae, a first relative angle between a slope from the one of the n others of the plurality of minutiae and the corresponding one of the plurality of minutiae and an orientation of the corresponding one of the plurality of minutiae, and a second relative angle between an orientation of the one of the n others of the plurality of minutiae and the orientation of the corresponding one of the plurality of minutiae.

30. The method of claim 27, wherein the transforming comprises applying a set of scaling vector to the first set of vectors to yield the second set of vectors.

31. A computer-readable medium having stored thereon a plurality for instructions for causing a computing device to perform any of claims 27-30.

32. An apparatus, comprising:
at least one processing element; and
a computer-readable medium having stored thereon a plurality for instructions for causing the at least one processing element to perform any of claims 27-30.
